(19) United States
(12) Patent Application Publication
(10) Pub. No.: US 2007/0076833 A1
(43) Pub. Date: Apr. 5, 2007

(54) Attenuated phase shift mask blank and photomask

(76) Inventors: Hans Becker, Meiningen (DE); Ute Buttgereit, Zella-Mehlis (DE); Guenter Hess, Meiningen (DE); Oliver Zberger, Meiningen (DE); Frank Schmidt, Jena (DE); Frank Sobel, Meiningen (DE); Markus Renno, Meiningen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/570,612

(22) PCT Filed: Sep. 6, 2004
(86) PCT No.: PCT/EP04/09919

§ 371 Date: Dec. 4, 2006

(30) Foreign Application Priority Data
Sep. 5, 2003 (US) 10655593
Jan. 22, 2004 (EP) 04001359.1
Apr. 8, 2004 (EP) 04008566.4

(51) Int. Cl. H04L 23/00

(52) U.S. Cl. 375/377

(57) ABSTRACT

The present invention relates to embedded attenuated phase shift mask blanks for use in lithography for an exposure wavelength of 300 nm or less, and a method of fabricating such mask blanks by ion beam deposition. In particular, the mask blanks comprise a substrate and a thin film system wherein the thin film system comprises a transmission control sublayer comprising one or more metals or metal compounds selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, borides and carbides thereof, and combinations of metals and compounds thereof; and a phase shift control sublayer comprising borides, carbides, oxides and/or nitrides of Ge, Si and/or Al or combinations thereof.

This application claims priority of U.S. patent application Ser. No. 10/655,593, and European patent applications application No. 04001359.1 and No 04008566.4, the content of which is incorporated herein by reference.

### FIELD OF THE INVENTION

The present invention relates to phase shift mask blanks for use in lithography for an exposure wavelength of 300 nm or less, and a method of fabricating such a mask blanks

### BACKGROUND OF THE INVENTION

There is considerable interest in phase shift masks as a route to extending resolution, contrast and depth focus of lithographic tools beyond what is achievable with the normal binary mask technology.

Among the several phase shifting schemes, the (embedded) attenuated phase shift masks proposed by Burn J. Lin, Solid State Technology, January issue, page 43 (1992), the teaching of which is incorporated herein by reference, is gaining wider acceptance because of its ease of fabrication and the associated cost savings.

Several technical variations of phase shift masks have been proposed. In a first variation, the substrate is provided with a slightly transparent layer, e.g. a very thin chrome layer, coupled with etching into the quartz substrate to produce the desired phase shift (Levinson type, hard type or alternating type phase shift mask). This method requires a high degree of control of both layer deposition and etch process.

In other variations, a phase shift mask is provided by applying one or more layers with phase shifting and attenuating properties on the substrate. There have been proposed single layer solutions in which one layer provides the 180° phase shift as well as the attenuation of the incident light. Besides single layer solutions, bilayer and multilayer attenuated phase shift mask blanks have also been described.

With the increasing requirements for the decreasing feature sizes of photomasks, the uniformity of the film thickness of the deposited layer is becoming increasingly important in the manufacture and processing of mask blanks. In order to deposit layers with defined optical properties, such as e.g. a defined phase shift, transmission and/or reflectivity, local deviations from the calculated layer thickness have to be avoided since such local deviations would result in non-uniform optical properties across the diameter of the mask blank. Therefore, controlling the uniformity of the layer thickness is becoming increasingly important.

Additionally, such photomask blanks should be substantially free of defects. Defects on the photomask blank may lead to defects such as pinholes in the photomask that results in defects in the IC devices. The task to avoid defects on mask blanks is becoming more challenging due to the decrease of the feature sizes. E.g. for the 65 and 45 nm nodes (i.e. feature sizes of 65 nm and 45 nm, respectively, on the wafer), a photomask is patterned with structures having a feature size of 100 nm and thus must be free from surface defects having a particle size of more than 0.5 μm.

It is therefore an object of the present invention to provide novel mask blanks for exposure wavelengths of 300 nm or less that combine the possibility of an easy and stable production with the necessary optical properties, chemical stability as well as a defect free surface and uniformly deposited layers.

### SUMMARY OF THE INVENTION

A first aspect of the invention is directed to a dual ion-beam deposition process for preparing an embedded attenuated phase shift mask blank, said mask blank comprising a substrate and a thin film system, said mask blank being able of producing a photomask with substantially 180° phase shift and an optical transmission of at least 0.001% at an exposure light having a wavelength of 300 nm or less; the process comprising depositing on the substrate
a transmission control sublayer comprising one or more metals or metal compounds selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, borides and carbides thereof, and combinations of metals and compounds thereof;
a phase shift control sublayer comprising borides, carbides, oxides and/or nitrides of Ge, Si and/or Al or combinations thereof;
   wherein at least one layer of the thin film system is deposited by
(a) ion beam deposition from a target of a mixture, alloy or compound containing one or more of Si, Al, Mg, Y, La, Ti, Zr, Hf, V, Nb, Ta, Cr, Mo, W, Mn, Fe, Co, Ni, Zn, Ge, Sn, Pb by ions from a group of gases using a primary ion beam, and
(b) bombarding the substrate using a secondary ion beam from an assist source comprising a group of gasses.

A second aspect of the invention is directed to an embedded attenuated phase shift photo mask blank, the mask blank comprising a substrate and a thin film system, said thin film system comprising
a transmission control sublayer comprising one or more metals and/or metal compounds selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, borides and carbides thereof and combinations of metals and compounds thereof;
a phase shift control sublayer comprising borides, carbides, oxides and/or nitrides of Ge, Si and/or Al or combinations thereof;
   wherein the transmission control sublayer and/or the phase shift control sublayer have a mean uniformity of film thickness of at most 2%; said mask blank being able of producing a photomask with substantially 180° phase shift and an optical transmission of at least 0.001% at an exposure light having a wavelength of 300 nm or less;

A third aspect of the invention is directed to an embedded attenuated phase shift mask blank, the mask blank comprising a substrate and a thin film system, said thin film system comprising
a transmission control sublayer comprising one or more metals and/or metal nitrides selected from the group consisting of Y, La, Ti, Zr, Hf, V, Nb, Ta, Cr, Mo, W, Mn, Fe, Co, Ni, Zn, Ge, Sn, Pb, nitrides thereof and combinations of metals and nitrides thereof; in an amount of at least 90 at.-%;
a phase shift control sublayer comprising oxides and/or oxy nitrides of Ge, Si and/or Al or combinations thereof; in an amount of at least 90 at.-%;
   said phase shift mask being able of producing a photomask with substantially 180° phase shift and an optical transmission of at least 0.001% at an exposure light having a wavelength of about 248 nm.

A forth aspect of the invention is directed to an embedded attenuated phase shift mask blank, comprising a substrate and a thin film system comprising
a transmission control sublayer comprising one or more metals and/or metal nitrides selected from the group consisting of Y, La, Ti, Zr, Hf, V, Nb, Ta, Cr, Mo, W, Mn, Fe, Co, Ni, Zn, Ge, Sn, Pb, nitrides thereof and combinations thereof; in an amount of at least 90 at.-%;
a contrast layer comprising one or more metal oxides in an amount of at least 90 at.-%, wherein the metal is selected from the group consisting of Y, La, Ti, Zr, Hf, V, Nb, Ta, Cr, Mo, W, Mn, Fe, Co, Ni, Zn, Ge, Sn, Pb, and combinations thereof;
a phase shift control sublayer comprising oxides or nitrides of Ge, Si and/or Al and/or combinations thereof; in an amount of at least 90 at.-%;
   said mask blank being able of producing a photomask with substantially 1800 phase shift and an optical transmission of at least 0.001% at an exposure light having a wavelength of 300 nm or less.

A fifth aspect of the invention is directed to an embedded attenuated phase shift mask blank, wherein the mask blank comprises a substrate and a thin film system comprising
a transmission control sublayer comprising one or more metals or metal nitrides selected from the group consisting of Y, La, Ti, Zr, Hf, V, Nb, Ta, Cr, Mo, W, Mn, Fe, Co, Ni, Zn, Ge, Sn, Pb, nitrides thereof and combinations thereof; in an amount of at least 90 at.-%;
a phase shift control sublayer comprising Si and/or Al;
a protection layer provided on the phase shift control sublayer, com prising a metal or compound selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, carbides, borides thereof and combinations thereof, said protection layer having a thickness of at most 5 nm;
   said mask blank being able of producing a photomask with substantially 180° phase shift and an optical transmission of at least 0.001% at an exposure light having a wavelength of 300 nm or less.

A sixth aspect relates to an embedded attenuated phase shift mask blank, wherein the mask blank comprises a substrate and a thin film system, said thin film system comprising
a transmission control sublayer comprising one or more oxides of a metal in an amount of at least 90 at.-%; wherein the metal is selected the from the group consisting of Y, La, Ti, Zr, Hf, V, Nb, Ta, Cr, Mo, W, Mn, Fe, Co, Ni, Zn, Ge, Sn, Pb, and combinations thereof;
a phase shift control sublayer comprising oxides and/or oxy nitrides of Si and/or Al or combinations thereof; in an amount of at least 90 at.-% said phase shift mask blank being able of producing a photomask with substantially 180° phase shift and an optical transmission of at least 20% at an exposure light having a wavelength of 300 nm or less.

These and other aspects, objects, features and advantages of the present invention will become apparent upon a consideration of the following detailed description and the invention when read in conjunction with the drawing FIGS.

It is to be understood that both the forgoing general description and the following detailed description are merely exemplary of the invention, and are intended to provide an overview or framework for understanding the nature and character of the invention as claimed.

### BRIEF DESCRIPTION OF THE DRAWINGS

In the Figures:

FIG. 1a shows a schematic diagram of a preferred apparatus for fabricating a mask blank according to the invention; FIG. 1b shows a schematic diagram of the assist source.

FIG. 2 shows a schematic cross section of an attenuated phase shift mask blank (FIG. 2a) and mask (FIG. 2c) according to an embodiment of the present invention and FIG. 2d shows a dry etch process that can be employed when structuring a mask blank according to this embodiment.

FIGS. 4a to 4d show schematic cross sections of mask blanks according to further embodiments of the present invention, a mask blank having a contrast layer (FIG. 4a), a mask blank having a protection layer (FIG. 4b), a mask blank having a contrast layer and a protection layer (FIG. 4c), and a mask blank having a four layer phase shift system (FIG. 4d).

FIG. 4 shows the dispersion curves of Ta and SiO₂.

FIGS. 5a and 5b show simulations of the transmission of mask blanks according to one embodiment of the invention as a function of the thickness of the transmission control sublayer and the phase shift control sublayer.

FIGS. 6a and 6b show simulations of the phase shift o a mask blank according to one embodiment of the invention as a function of the thickness of the phase shift control sublayer and the transmission control sublayer.

FIGS. 7a to 7e show simulations of the variation of the transmission of exemplary attenuated phase shift mask blanks according to an embodiment of the invention depending on the thickness of the transmission control sublayer and the phase shift control sublayer for use at exposure wavelengths of 157, 193 and 248 nm.

FIG. 8 shows the optical density depending on the wavelength of a mask blank according to one embodiment of the present invention (oscillating line).

FIGS. 9a and 9b show spectral reflection and transmission curves for mask blanks according to certain embodiments of the invention.

FIGS. 10a and 10b show the transmission uniformity of a 157 nm attenuated phase shift mask blanks according to Comparative Example 1 (FIG. 10a) and Inventive Example 1 (FIG. 10.b).

FIGS. 10c and 10d show the thickness uniformity of a Ta layer of a 157 nm attenuated phase shift mask blanks according to Comparative Example 1 (FIG. 10c) and Inventive Example 1 (FIG. 10d).

FIGS. 11a and 11b show the thickness uniformity of a SiO₂ layer of a 157 nm attenuated phase shift mask blanks according to Comparative Example 1 (FIG. 11a) and Inventive Example 1 (FIG. 11b).

FIGS. 12a, 12b and 12c show the AFM measured surface on an SiO₂ film of a 157 nm attenuated phase shift mask blank according to Comparative Example 1 (FIG. 12a), Comparative Example 2 (FIG. 12b) and Example 1 (FIG. 12c).

FIGS. 13a and 13b show defect maps of a 157 nm attenuated phase shift mask blank according to Example 1.

FIGS. 14a and 14b show analyses of particles, i.e. defect levels of 157 nm attenuated phase shift mask blanks according to Example 1.

FIGS. 15a and 15b show long term film thickness drifts of Ta and SiO₂ films caused by target erosion.

FIG. 16 shows a SEM picture of an etched mask blank according to one embodiment of the invention.

FIGS. 17a and 17b show SEM pictures of etched mask blanks according to further embodiments of the invention.

FIGS. 18a and 18b show calculations on the influence of a contrast layer on a mask blank according to one embodiment of the present invention.

FIG. 19 shows the laser durability of a Ta layer.

FIG. 20 shows the chemical durability of a mask blank according to one embodiment of the invention.

FIG. 21 show comparisons of a GIXR and n&k curves before and after chrome absorber dry etch of a mask blank having a protection layer according to an embodiment of the invention.

FIG. 22 shows the reflection and transmission at an inspection wavelength of 256 nm of a mask blank according to an embodiment of the invention.

### DETAILED DESCRIPTION OF THE PREFERRED EMBODIMENTS

As known in the art, a “photomask blank” or “mask blank” differs from a “photomask” or “mask” in that the latter term is used to describe a photomask blank after it has been structured or patterned or imaged. While every attempt has been made to follow this convention herein, those skilled in the art will appreciate the distinction in not a material aspect of this invention. Accordingly, it is to be understood that the term “photomask blank” or “mask blank” is used herein in the broadest sense to include both imaged and non-imaged photomask blanks.

The expression “having a phase shift of substantially 180°” means that the phase shift mask blank provides a phase shift of the incident light sufficient to cancel out light in the boundary section of a structure and thus to increase the contrast at the boundary. Preferably, a phase shift of 160° to 190°, more preferably of 170° to 185° is provided. According to the present invention, the expressions “under” and “on” when used to describe the relative position of a first layer to a second layer in the layer system of the mask. blank have the following meaning: “under” means that said first layer is provided closer to the substrate of the mask blank than said second layer and the expression “on” means that said first layer is provided further remote from the substrate than said second layer.

Furthermore, if not explicitly mentioned otherwise, the expressions “under” or “on” can mean “directly under” as well as “under, but at least one further layer is provided in between said two layers” or “directly on” as well as “on, but at least one further layer is provided between said two layers”.

The mask blank of the present invention has a transmission of at least 0.001%, preferably of at least 0.5%, at an exposure light having a wavelength of 300 nm or less.

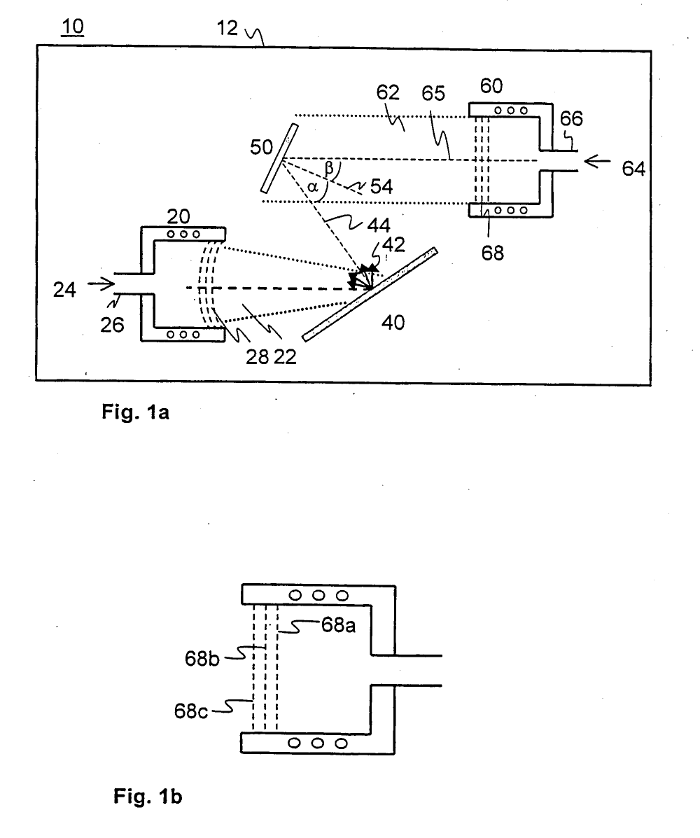

FIG. 1 schematically shows an exemplary setup of a deposition apparatus 10 for manufacturing of photo mask blanks by ion beam sputtering (IBS) or ion beam deposition (IBD) according to the present invention. The apparatus 10 comprises a vacuum chamber 12 which can be evacuated by a pump system.

A deposition particle source or more specifically ion deposition source 20 creates a first particle or ion beam 22. The deposition ion source 20 is a high frequency (HF) ion source, however, also other types of ion sources may be used. The sputter gas 24 is led into the deposition ion source 20 at inlet 26 and is ionized inside the deposition ion source 20 by atomic collisions with electrons that are accelerated by an inductively coupled electromagnetic field. A preferably curved three grid ion extraction assembly 28 is used to accelerate the primary ions, comprised in the first ion beam 22 and focus them towards the target 40.

The primary ions are extracted from the deposition ion source 20 and hit a target or sputter target 40, thereby causing cascades of atomic collisions and target atoms are bombed out. This process of sputtering or vaporizing the target is called the sputter process. The sputter target 40 is e.g. a target comprising or consisting of tantalum, titanium, silicon, chrome or any other metal or compound as mentioned below, depending on the layer to be deposited. The deposition apparatus may be equipped with a plurality of different sputter targets that differ in respect of the chemical composition in a way that the sputtering process can be changed to another target without the need to interrupt the vacuum. Preferably, the sputter process and the deposition of the layers take place in a suitable vacuum.

The momentum transfer to the target atoms is at largest, when the mass of the primary ions is equivalent to the mass of the target atoms. As noble gases are easy to handle, preferably helium, argon or xenon is used as the sputter gas 24. Xenon is preferred as a sputter gas since the use of Xenon during sputtering increases the uniformity of the thickness of the deposited layers.

At least a portion of the sputtered ions 42 emerges from the target 40 in direction to substrate 50. The sputtered ions 42 hit the substrate 50 with an energy which is much higher than with conventional vapor deposition, deposition or growing highly stable and dense layers or films on the substrate 50.

In particular, the mean energy of the sputtered atoms, e.g. metal atoms, is adjusted or controlled by the energy and/or the incident angle of the first ion beam 22. The incident angle of the first ion beam 22 with respect to the target normal line 44 is adjusted by pivoting the target 40.

The substrate 50 is rotatably mounted in a three-axis rotation device. The mean incident angle α of the sputtered ions with respect to normal line 54 of the substrate 50 is adjusted by pivoting the substrate 50 around a first axis. By adjusting the incident angle a uniformity, internal film structure and mechanical parameters, in particular film stress can be controlled and consequently improved.

Furthermore, the substrate 50 can be rotated perpendicular to the normal line 54 representing a second axis of rotation, to further improve the uniformity of the deposition.

The substrate is additionally rotatable or pivotable around a third axis, allowing it to move the substrate out of the beam to allow for example cleaning of the substrate 50 immediately before deposition.

Furthermore, the apparatus 10 comprises an assist particle source or assist ion source 60. The operation principle is the same as the deposition source 20. A second particle or ion beam 62 is directed towards the substrate 50, e.g. for flattening, conditioning, doping and/or further treatment of the substrate 50 and/or films deposited on the substrate 50. Further active and/or inactive gases 64 may be introduced via gas inlet 66.

The second ion beam 62 is accelerated preferably by a straight three grid extraction system 68.

FIG. 1b shows a schematic view of the assist source. Like the deposition source, the assist source comprises three grids, the so-called Accel grid 68a, the so-called Decel grid 68b and the so-called Ground 68c. Between Accel grid 68a and Decel grid 68b the ions are accelerated and on the second part of their path to Ground 68c decelerated. This allows influencing the divergence of the ion beam.

Preferably, assist source 60 is used to introduce active gasses such as oxygen and nitrogen to the system.

The second ion beam 62 substantially covers the whole substrate 50 to obtain a uniform ion distribution or treatment all over the substrate area. As can be seen in FIG. 1 the substrate 50 is tilted by an angle b with respect to the axis 65 of the second ion beam 62.

In the state of the art, the second ion beam 62 is particularly used to
dope the films with oxygen, nitrogen, carbon and/or other ions,
clean the substrate, for example with an oxygen plasma, before the deposition,
improve the interface quality of the films by flattening the films.

However, according to the present invention the second or secondary ion beam can advantageously been used to improve the uniformity of the thickness of a deposited layer. In particular when sputtering light metals such as Si, Al, Mg and Ge or when the assist source is used to dope the sputtered metal layer with elements such as O and/or N to produce a layer of an oxide, nitride or oxy nitride of said metal, it has been found that it is difficult or even impossible to sputter a layer having a very uniform layer thickness using the usual means to improve the uniformity such as changing the target angel or varying the sputter gasses. In general, more atoms of the sputtered metal are deposited towards the middle of the mask blanks, less atoms are deposited towards the sides or side portions of the mask blank thus leading to a deposited layer having a higher thickness in the middle portion relative to the side portions of the mask blank. However, it has also been found that it is possible to modulate the ion beam of the assist source in a way to compensate this effect. Using the ion beam of the assist source it is possible to etch the sputtered layer in a predefined way, i.e. to etch the middle portion of the mask blank stronger than the side portions of the mask blank to an amount that the final layer has a very uniform layer thickness across the whole surface of the mask blank.

To achieve this effect, it is necessary to modulate the parameters for generating the first or primary ion beam used for deposition and the parameters for generating the second or secondary ion beam of the assist source. Such modulation influences the statistical distribution of geometry, i.e. the “geometrical form” of the ion beams and energy of the ion beams thus leading to a compensating effect.

Several parameters have to be adjusted to modulate the primary and the secondary ion beam.

First of all, the rate of deposition versus the rate of etching is important for the compensation effect. The rate of deposition by the ion beam of the deposition source is primarily determined by the ion current of the deposition source I_{B} ( ), the rate of etching by the ion beam of the assist source is primarily determined by the ion current of the assist source I_{A}.

Furthermore, the form of the ion beams, i.e. the statistical distribution the sputtered ions is determined by the following parameters:
Mass of the primary ions,
Incident angles of the primary and secondary ion beams α and β on the substrate
Voltage and current applied at the Accel grids of deposition source and assist soure,
Voltage applied at the Decel grid of the deposition source and the assist source

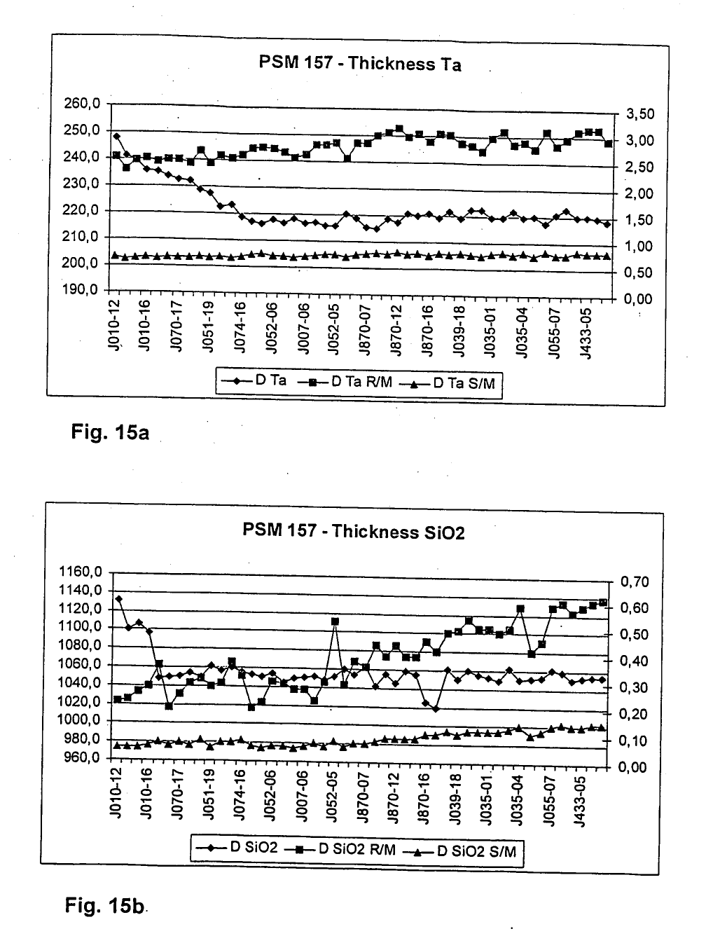

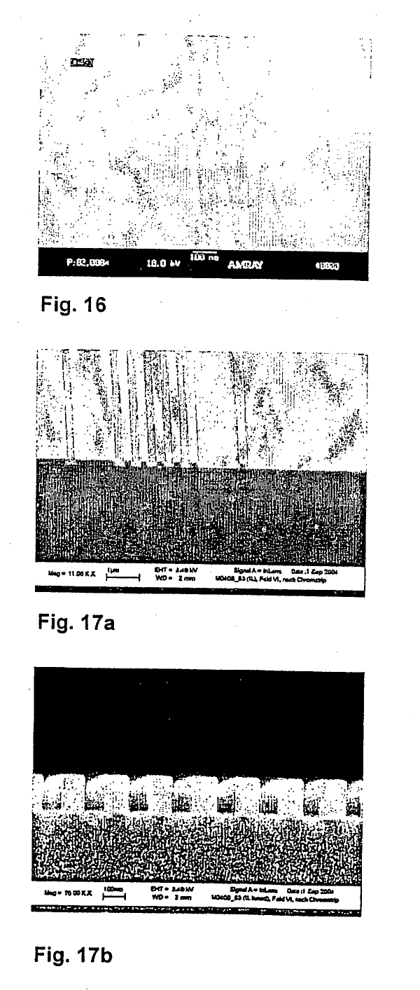

The atomic beam generated by bombarding primary ions from the deposition source on the target is furthermore influenced by density, purity and form of the target. During repeated sputtering processes erosion of sputtered atoms lead to a change of the form of the target. As shown in FIGS. 15a and 15b, the thickness of the Si and the Ta layers show a small drift from the starting value when measured over repeated sputtering experiments. This drift is attributed to the target erosion. It is therefore preferred to repeat the calibration after a certain amount of sputtering experiments have been performed such as e.g. after having sputtered 20 mask blanks. However, this number is depending on the thickness of the layer deposited.

For determining the parameters for modulating the ion beam of the deposition source and the ion beam of the assist source, preferably a DOE (Design of Experiment) method is used. Such DOE methods and software performing them are commercially available and known in the state of the art. The set of parameters and ranges for said parameters to be used to perform the DOE has to be selected appropriately.

According to a preferred embodiment of the present invention, it is preferred to use for the DOE the following parameters and ranges:
current of deposition source (IBD), preferably from 100 to 500 mA more preferably from 200 to 300 mA
current ,of assist source (IBA), preferably from 50 to 300 mA, more preferably from 80 to 200 mA
voltage of deposition source (UBD), preferably from 500 to 1500 V, more preferably from 1000 to 1500 V
voltage of assist source (UBA), preferably from 50 to 150 V
voltage of suppressor (Decel grid, divergence) of deposition source (USD), preferably from 100 to 300 V
voltage of suppressor of assist source (USA), preferably 100 to 500 V, more preferably from 150 to 300 V

It is preferred to use a fixed target angel of preferably from 35 to 50° and a fixed fixture angle of from 45 to 60° for the DOE.

Etching of the deposited layer can be performed simultaneously to the deposition process or also after deposition of the layer was finished. In case etching is performed after the end of the deposition, it is preferred to use in active gasses such a noble gas in the assist source.

In case etching is to be performed during the deposition process and an oxide or nitride of a metal or semimetal is to be sputtered, it is preferred to use a target of the elemental metal or semimetal and to introduce oxygen and/or nitrogen via the inlet of the assist source.

In case an elemental metal or semimetal or a mixture thereof is to be sputtered, a target of such elemental metal or semimetal and to use a noble gas such as argon or xenon in the assist source.

As the sputtering targets, targets comprising elements or targets comprising components can be used. In case the deposited layer contains an oxide, nitride or oxy nitride of a metal or semimetal, it is possible to use such oxide, nitride or oxy nitride of a metal or semimetal as the target material. However, it is also possible to use a target of a metal or semimetal and to introduce oxygen and/or nitrogen as an active sputtering gas. In case of the deposition of SiO₂, it is preferred to use a target of Si and to introduce oxygen as an active sputtering. gas. In case the deposited layer shall comprise nitrogen, it is preferred to introduce nitrogen as an active sputtering gas.

For the sputtering gas, it is preferred to use inactive gasses such as helium, argon or xenon. Such inactive gasses can be combined with active gasses such as oxygen, nitrogen, nitrogen monoxide, nitrogen dioxide, and dinitrogen oxide or mixtures thereof. Active gasses are gasses that may react with sputtered ions and thus become part of the deposited layer. According to a preferred embodiment of the present invention, during the sputtering of the phase shift control layer, a mixture of an inactive gas and oxygen is used as an additional sputtering gas.

In case bilayer or multiplayer mask blanks are manufactured, it is preferred to deposit all layers in a single chamber of deposition apparatus without interrupting the ultra high vacuum. It is particularly preferred to deposit layers of a phase shift layer without interrupting the vacuum, in case a bilayer or multi-player phase shift mask blank is manufactured. Thus, the decontamination of the mask blank with surface defects is avoided and a mask blank substantially free of defects can be achieved. Such a sputtering technique can e.g. be realized by using a sputter tool that allows sputtering from several targets. Thus, high quality phase shift masks having a low defect density and/or highly uniform layers with respect to the thickness of the layers can be achieved.

Furthermore, embedded attenuated mask blanks for lithography wavelengths of less than 300 nm are provided, wherein said mask blank comprises a substrate and a thin film system provided on the substrate.

The substrate material for a mask blank according to the present invention preferably is formed of high purity fused silica, fluorine doped fused silica (F—SiO₂), calcium fluoride, and the like.

Besides the phase shift system, said thin film system may comprise layers such as one or more anti reflective layers, a barrier or protection layer, an inspection control or contrast layer and/or an absorbing layer or absorber layer. As such an absorbing layer, e.g. a chromium or TaN layer may be provided. A “chromium” absorber layer may contain O and/or N in addition to chromium.

The thin film system of mask blank may be free from defects having a particle size of 0.5 μm or more. Preferably, said thin film system has at most 50 defects, more preferably at most 20 defects, having a particle size of 0.3 μm to 0.5 μm. With decreasing feature sizes on a photomask, defects having a size of 500 nm or more will pose a problem and therefore must not be present. With respect to defects having a particle size of 0.3 to 0.5 μm, a limited amount of up to 50 defects per mask blank is tolerable for many applications.

Furthermore, the mask blank may have a surface roughness (RMS) of at most 5 Å according to specific embodiments of the present invention. Using the assist source according to the present invention improves the surface roughness of particularly a SiO₂ layer. FIG. 12a to c shows the AFM measured surface roughness of a SiO₂ layer according to comparative examples (12a and 12b) without the use of the assist source and an inventive example (12c).

According to the second aspect of the invention, one, some or all of the layers and sublayers of the thin film system may have a mean uniformity of film thickness of at most 2%, preferably of at most 1%, more preferably of at most 0.5%. Providing a phase shift system having a highly uniform layer thickness results in a phase shift mask blank having a high uniformity in view of the phase shift and the transmission on all positions of the mask blank. In particular, the phase shift of said phase shift mask blank may have a deviation from the mean value of the phase shift of at most about ±2°, more preferably of at most ±1.5°, and the transmission of said phase shift mask blank may have a deviation from the mean transmission value of at most about ±0.5%.

The phase shift mask blank comprises a phase shift system comprising a bilayer or multilayer phase shift system wherein the expression “multilayer” includes any number of layers starting from at least three layers. The layers (or sublayers) of the phase shift system in general may comprise different functions or functionalities.

The at least bilayer phase shift system of the phase shift mask blank according to the invention comprises a transmission control sublayer and a phase shift control sublayer.

Substantially separating the phase shift function and the attenuating function into at least two separate sublayers is particularly advantageous for an attenuated phase shift mask blank for exposure wavelengths of 300 nm or less. Such an attenuated phase shift mask blank can easily be tuned with respect to the transmission of the mask blank without the need of changing the composition of the sublayers but simply by variation of the thickness of the transmission control sublayer. The phase shift of the mask blank can be easily tuned without substantially changing the transmission of the mask blank by varying the thickness of the phase shift sublayer. Tuning of the phase shift of a mask blank often is necessary to adapt the mask blank to the etching process. During such etching process, the substrate is often etched to a defined depth, thus adding an additional phase shift to the phase shift system. In order to adapt the mask blank to this etching into the mask blank, it may be necessary to set the phase shift not to exactly 180° but to a value from about 175° to 180° phase shift depending on the etching process.

Thus, the phase shift mask blank comprises a substrate and a phase shift system, wherein the phase shift system according comprises a phase shift control sublayer that substantially does not lower the transmission of the mask blank and/or a transmission control sublayer that substantially does not change the phase shift of the mask blank.

The wording “substantially not changing the phase shift of the mask blank” means that the phase shift of the mask blank is changed to an amount of at most 15°, preferably at most about 10°, most preferably at most about 5°, of the overall phase shift.

According to the present invention, by the wording “substantially not lowering the transmission of the mask blank” is meant that the phase shift control sublayer lowers the transmission of the mask blank to a value of at most about 10%, preferably at most about 5% of the transmission.

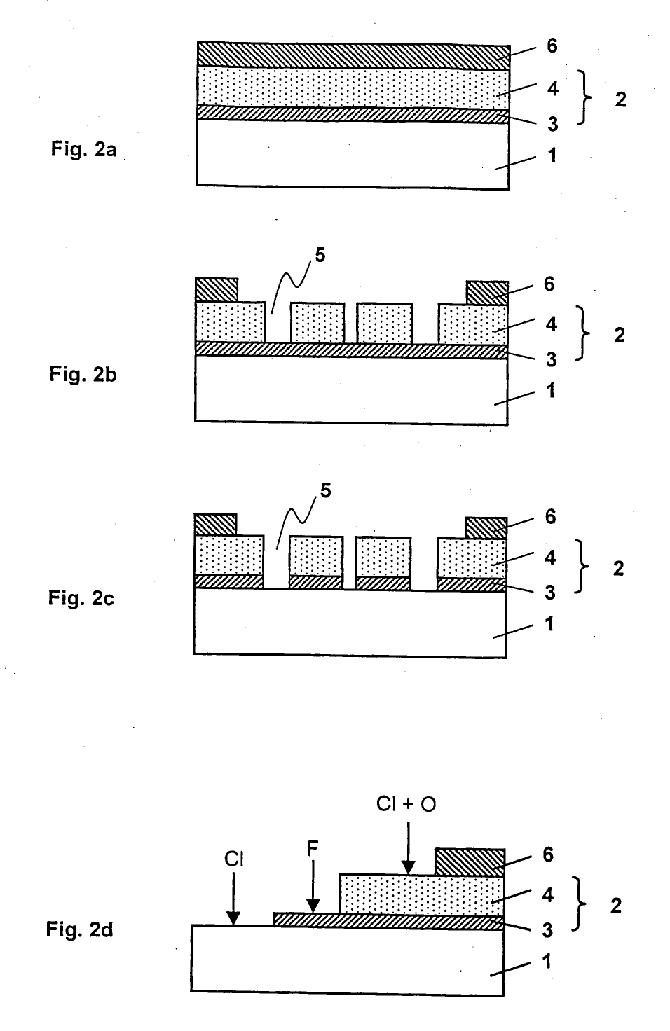

Referring to FIG. 2a, the mask blank according to one embodiment of the present invention comprises a substrate 1 on which a phase shift system 2 is provided. The phase shift system 2 is composed of a transmission control sublayer 3 and a phase shift control sublayer 4. Preferably, the transmission control sublayer 3 is provided as the first sublayer of phase shift layer on the substrate 1 and the phase shift control sublayer 4 is provided on the transmission control sublayer as the second sublayer of the phase shift layer as also shown in FIG. 2a. However, according to another embodiment, the phase shift control sublayer may be provided as a first sublayer of the phase shift layer on the substrate and the transmission control sublayer is provided as the second sublayer of the phase shift layer on the phase shift control sublayer. On the phase shift system, in general an absorber layer 6 is provided. For transforming the phase shift mask blank shown in FIG. 2a into an imaged or patterned or structured photo mask as shown in FIG. 2c, preferably, a two step etching process of the phase shift system is preferred. As shown in FIG. 2d, at first the absorbing layer 6 may be etched using a first etching process such as e.g. a dry etching process using a combination of chlorine and oxygen. Then, the first sublayer 4 of the phase shift system 2, preferably the phase shift control sublayer is patterned using a second etching agent, such as e.g. a fluorine based dry etching agent. In a last step, the second sublayer 3 of the phase shift system 2, preferably the transmission control sublayer is patterned preferably using a further etching agent, such as e.g. a chlorine dry etching agent. The first etching agent may be the same or different from the last etching agent.

The phase shift control sublayer comprises a material selected from the group consisting of borides, carbides, oxides and/or nitrides of Ge, Si and/or Al or combinations thereof. According to certain embodiments of the present invention, the phase shift control sublayer comprises a material selected from the group consisting of borides, carbides, oxides and/or nitrides of Ge, Si and/or Al or combinations thereof in an amount of at least 90 at.-%, preferably in an amount of at least 95 at.-%.

According to one embodiment, the phase shift layer essentially consists of one or more materials or a mixture of materials having a value for the extinction coefficient k of about 0.3 or less, more preferably of about 0.05 or less at exposure light wavelength.

The phase shift control sublayer may also contain small amounts of metals selected from the group consisting of Mg, Y, La, Ti, Zr, Hf, V, Nb, Ta, Cr, Mo, W, Mn, Fe, Co, Ni, Zn, Sn, Pb and mixtures thereof. However, since the incorporation of these metals tends to lower the transmission of the phase shift control sublayer, it is preferred that these metals are incorporated only in an amount of at most 5 at. %. According to certain embodiments, the phase shift control sublayer is essentially free from such metals. Furthermore, phase shift control sublayers containing metals as mentioned above, and in particular in amounts of more than 5 at. % are prone to result in mask blanks having higher defect levels. The incorporation of such metals, in particular in amounts of more than 5 at. %, therefore is also not preferred from the viewpoint of a low defect level of the thin film system of the phase shift mask blank.

According to one embodiment, the phase shift control sublayer comprises oxides and/or oxy nitrides of Si, Al and/or Ge and/or combinations thereof in an amount of at least 90 at.-% preferably at least 95.-%. According to a further embodiment, nitrogen added to the phase shift control sublayer only in an amount of at most about 10 at. %, more preferably of at most about 5 at. %.

According to one embodiment of the present invention, the phase shift control sublayer essentially consists of SiO₂.

The phase shift control sublayer has a thickness adjusted to provide a phase shift of about 180° at an exposure light wavelength in the range of 300 nm or less or any other required phase shift.

The thickness of the phase shift control sublayer necessary to achieve a determined phase shift depends on the refractive index or index of refraction n and the extinction coefficient k of the material the phase shift sublayer is formed of. As a general rule, a material with a higher index of refraction will lead to a larger phase shift per deposited thickness of the phase shift sublayer than a material with a lower index of refraction.

The transmission control sublayer comprises one or more metals or metal compounds selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, borides and carbides thereof, and combinations of metals and compounds thereof.

According to one embodiment of the invention, the transmission control sublayer comprises at least one material having a comparatively high opacity and comprises a material selected from the group consisting of Mg, Y, La, Ti, Zr, Hf, V, Nb, Ta, Cr, Mo, W, Mn, Fe, Co, Ni, Zn, Ge, Sn, Pb, nitrides thereof and mixtures of two or more of these metals or nitrides. According to a specific embodiment, the transmission control layer comprises a metal selected from the group consisting of Ta, Ti, Zr, Hf, V, Nb, Cr, Mo, and W. Preferably, the transmission control sublayer comprises the aforementioned metals and compounds in an amount of at least 90 at.-%, more preferably of at least 95 at.-%. According to a further embodiment, the transmission control sublayer consists of at lease one material selected from the group consisting of Nb, Ta, Ti, Cr, Mo, W, V, Nb, Zn, Zr, Hf, Si, Ge, Sn, Pb, Mn, Fe, Co, Ni, La, Mg, and nitrides and mixtures of two or more of these metals or nitrides thereof. In this context, one material may means e.g. one elemental metal, such as a layer of Ti, Ta or Hf, or one metal nitride, such as TaN, TiN or HfN.

The transmission control sublayer has sufficient thickness to adjust the transmission of the phase shift system to the desired value and its thickness essentially depends on the material of the transmission control sublayer. The thickness can be calculated by the following formula:
d_{Tc}=−1/α_{λ}×ln(T/100)
wherein T is the desired transmission in %, α_{λ} is the absorption coefficient at the exposure wavelength λ and d_{Tc} is the calculated thickness of the transmission control sublayer. The absorption coefficient α relates to the extinction coefficient k according to the following formula:
α=4πk_{λ}/λ

According to an embodiment of the invention, the transmission control layer is provided directly on the substrate and also provides an etch stop function, i.e. has a high etch selectivity to the quartz substrate. Thus, over-etching of the phase shift mask into the quartz substrate can easily be prevented. According to this embodiment of the present invention, the transmission control sublayer has a thickness of preferably at least about 8 nm, most preferably of at least about 10 nm. If the thickness is less than about 8 nm, the etch stop function of the transmission control sublayer is not sufficient.

According to this embodiment of the present invention the transmission control sublayer preferably has an etching selectivity different from the phase shift control sublayer. If the phase shift control layer is etched using a fluorine containing component, the transmission control layer preferably is etched by a dry etching method using a chlorine-based gas such as Cl₂, Cl₂+O₂, CCl₄, CH₂Cl₂, or a wet etching using acid, alkali or the like. However, a dry etching method is preferred. As an etching method using a fluorine containing component, reactive ion etching (RIE) using fluorine gasses such as CHF₃, CF₄, SF₆, C₂F₆ and mixtures thereof is preferred.

According to forth aspect of the present invention, an phase shift mask blank comprising an “inspection control layer” or “contrast layer” is provided. One embodiment of this aspect is shown schematically in FIGS. 3a and 3c, wherein a contrast layer 8 is positioned on the transmission control sublayer 3.

Mask blanks are submitted to inspection procedures at wavelength longer than the illumination wavelength. E.g. a mask blank for 193 nm lithography will generally be inspected at inspection wavelength of e.g. 257 nm and 356 nm. In order to make an inspection at these wavelengths possible, mask blanks for 193 nm lithography must not only have required transmission and phase shift at the exposure wavelength, but should also obey to certain maximum transmission and reflection at inspection wavelength.

According to the invention, a “inspection control” or “contrast” layer in particular provides an improved contrast at inspection wavelength such as e.g. 257 nm and/or 356 nm. It may improve the reflection, i.e. impart an anti reflection property to the phase shift mask blank at the inspection wavelength and or exposure wavelength or it may help to control the transmission at inspection wavelength within a predetermined range.

Since such contrast layer in general also changes the transmission and/or phase shift of the phase shift system at the exposure wavelength, the thickness of the phase shift control sublayer and/or the thickness of the transmission control sublayer have to be adapted in order to secure required phase shift and transmission at the exposure wavelength, i.e. the thickness of the phase shift control sublayer has to be reduced by the amount the contrast layer adds to the phase shift and/or the thickness of the transmission control sublayer has to be reduced by the amount the contrast layer adds to the transmission.

According to one embodiment, the transmission control sublayer is provided on the substrate, and the phase shift control sublayer is provided on the transmission control sublayer and the contrast layer is provided on the phase shift control sublayer. According to a further embodiment, the transmission control sublayer is provided on the substrate, the contrast layer is provided on the transmission control layer, and the phase shift control sublayer is provided on the contrast layer.

A contrast layer preferably may comprise one or more metal oxides in an amount of at least 90 at.-%; wherein the metal is selected from the group consisting of Y, La, Ti, Zr, Hf, V, Nb, Ta, Cr, Mo, W, Mn, Fe, Co, Ni, Zn, Ge, Sn, Pb, and combinations thereof. According to a specific embodiment, the transmission control layer comprises a metal selected from the group consisting of Ta, Ti, Zr, Hf, V, Nb, Cr, Mo, and W.

According to this forth aspect of the present invention, the transmission control sublayer preferably comprises one or more metals and/or metal nitrides selected from the group consisting of Y, La, Ti, Zr, Hf, V, Nb, Ta, Cr, Mo, W, Mn, Fe, Co, Ni, Zn, Ge, Sn, Pb, nitrides and combinations thereof; in an amount of at least 90 at.-%; and the phase shift control sublayer preferably comprises oxides or nitrides of Ge, Si and/or Al and/or combinations thereof; in an amount of at least 90 at.-%;

According to a specific embodiment, the transmission control sublayer comprises a metal as mentioned above, e.g. Ta in amount of at least 90 at.-%, preferably at least 95 at.-%. In such a case, the contrast layer preferably comprises at least 90 at.-%, more preferably at least 95 at.-% of an oxide of the same metal as used for the transmission control sublayer, e.g. Ta₂O₅. However, other metal oxides such as Cr₂O₃ are also possible.

According to an embodiment, the phase shift control sublayer comprises SiO₂ in an amount of at least 95 at.-% and/or the transmission control sublayer comprises Ta and/or Ta nitride in an amount of at least 95 at.-% and/or the contrast layer comprises Ta₂O₅ in an amount of at least 95 at.-%.

According to a further specific embodiment, the contrast layer comprises the same etch selectivity as the transmission control sublayer and/or as the phase shift control sublayer. Thus, the number of etching steps should preferably not be increased by the insertion of a contrast layer.

According to a certain embodiment, the mask blank of the invention has a transmission at one or more inspection wavelengths of at most 50% and/or a reflection at one or more inspection wavelength of at most 20%.

The contrast layer preferably has a thickness of at most 30 nm, more preferably of at most 20 nm.

According to a fifth aspect, the mask blank may comprise a “barrier layer” or “protection layer”, said protection layer having a thickness of at most 5 nm. One embodiment of this aspect is shown schematically in. FIGS. 3b and 3c, wherein a protection layer 8 is positioned on the phase shift control sublayer 4.

In case the phase shift control sublayer comprises Si and/or Al, the phase shift control sublayer may be prone to degradation when exposed to alkaline, acidic or other aggressive cleaning agents. However, in case the thickness of the phase shift control sublayer is reduced by such cleaning procedures, this can change the phase shift of the phase shift mask blank and therefore is not preferred. According to this aspect, the transmission control sublayer is usually provided on the substrate and the phase shift control sublayer is provided on the transmission control sublayer. The protection layer may additionally protect a Si and/or Al containing layer during wet etching processes.

Furthermore, the protection layer may serve to avoid the so-called “haze” effect occurring in photomasks for use in 193 nm lithography which is thought to be generated by the generation of crystals during the cleaning of the photomasks. Due to the protection layer deposited on a Si and/or Al containing layer, the precipitations of crystals on the Si and/or Al containing layer can be avoided.

According to certain embodiments, said protection layer has a thickness of at most 4 nm, preferably at most 2 nm. In general, a thickness of at least 0.2 nm for the protection layer suffices to impart a protection function towards alkaline, acidic and/other aggressive cleaning agents to the layer system, however, according to certain embodiments of the present invention, the protection layer has a thickness of at least 0.5 nm or even at least 0.7 nm, depending e.g. on the aggressiveness of the alkaline cleaning agent to be employed.

According to another embodiment of the present invention, the protection layer essentially does not alter the optical properties of the mask blank and photomask to be manufactured. Optical properties are e.g. the phase shift, the transmission and the reflectivity properties of the mask blank.

The protection layer may have an etching selectivity different from the etching selectivity of the layer directly on the protection layer. In this case, the protection layer remains on the Si and/or containing layer and should have the same etch selectivity as the Si and/or Al containing layer in order not to increase the number of necessary etching steps. The protection layer may also have the same etching selectivity as the layer directly on the protection layer.

A protection layer may be provided on a phase shift control sublayer containing Si and/or Al and/or a further layer containing Si and/or Al and may comprising a metal and/or compound selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, carbides, borides and combinations thereof. According to a specific embodiment, the transmission control layer comprises a metal selected from the group consisting of Ta, Ti, Zr, Hf, V, Nb, Cr, Mo, and W. The protection layer preferably comprises an oxide or oxy nitride of a metal in an amount of at least 90 at.-%, wherein the metal is selected from the group consisting of Mg, Y, La, Ti, Zr, Hf, V, Nb, Ta, Cr, Mo, W, Mn, Fe, Co, Ni, Zn, Ge, Sn, Pb, and combinations thereof.

According to this fifth aspect, a transmission control sublayer may comprise a metal or metal nitride selected from the group consisting of Y, La, Ti, Zr, Hf, V, Nb, Ta, Cr, Mo, W, Mn, Fe, Co, Ni, Zn, Ge, Sn, Pb, nitrides and combinations thereof; in an amount of at least 90 at.-%. The phase shift control sublayer may comprise oxides and/or nitrides of Si in an amount of at least 90 at.-%.

A sixth aspect of the invention relates to a high transmission mask blank providing an optical transmission of at least 20% at an exposure light having a wavelength of 300 nm or less. According to certain embodiments the transmission of a mask blank according to this sixth aspect may be at least 30%, preferably at least 40%, more preferably at least 50%. However, even in case a mask blank having a transmission of 20% is to be produced, a mask blank according to this sixth aspect is advantageous since the overall thickness of the thin film system can be reduced due to the reduced thickness of the phase shift system.

According to this aspect, a transmission control sublayer preferably comprises an oxide of a metal in an amount of at least 90 at.-%; wherein the metal is selected the from the group consisting of Y, La, Ti, Zr, Hf, V, Nb, Ta, Cr, Mo, W, Mn, Fe, Co, Ni, Zn, Ge, Sn, Pb, and combinations thereof.

According to this aspect, a phase shift control sublayer may comprise oxides and/or oxy nitrides of Si and/or Al or combinations thereof; in an amount of at least 90 at.-%

According to one embodiment of this aspect of the present invention, a reflection improved high transmission mask blank is provided in an alternating orde on the substrate, comprising
a transmission control sublayer comprising an oxide of a metal in an amount of at least 90 at.-%, wherein the metal is selected the from the group consisting of Y, La, Ti, Zr, Hf, V, Nb, Ta, Cr, Mo, W, Mn, Fe, Co, Ni, Zn, Ge, Sn, Pb, and combinations thereof;
a phase shift control sublayer comprising oxides and/or oxy nitrides of Si and/or Al or combinations thereof; in an amount of at least 90 at.-%;
a transmission control sublayer comprising an oxide of a metal in an amount of at least 90 at.-%, wherein the metal is selected the from the group consisting of Y, La, Ti, Zr, Hf, V, Nb, Ta, Cr, Mo, W, Mn, Fe, Co, Ni, Zn, Ge, Sn, Pb, and combinations thereof;
a phase shift control sublayer comprising oxides and/or oxy nitrides of Si and/or Al or combinations thereof in an amount of at least 90 at.-%.

Different aspects of the present invention may be combined with each other as appropriate, e.g. one or several protection layer(s) and/or contrast layer(s) may be present also in mask blanks of other aspects of the invention. Furthermore, as outlined for one embodiment of the sixth aspect, the invention is not limited to phase shift systems having only one phase shift control sublayer and/or only one transmission control sublayer. Two or more transmission control sublayers and/or phase shift control sublayers may be present in a mask blank according to the invention. Such two or more transmission control sublayers and/or phase shift control sublayers may comprise the same material or may comprise different materials. Furthermore, the layers may be formed of a homogeneous material or may have a gradual change of composition within different distances from the substrate.

The present invention also relates to structured photo masks which have been manufactured by structuring the mask blanks as mentioned above and to methods of manufacturing such photomasks.

### EXPERIMENTS

In the foregoing and in the following examples, all temperatures are set forth uncorrected in degrees Celsius. The entire disclosure of all applications, patents and publications, cited above and below, is hereby incorporated by reference.

In the following, the design and fabrication of mask blanks according to a preferred embodiment of the present invention are described.

Exemplary Film Design and Transmission Tuning

The n and k values were obtained at 157 and 193 nm from the ellipsometer measurement using a model Woollam VASE Spectroscopic Ellipsometer. Typically, the spectroscopic scan was taken at 55 and 65 degrees. Transmission data was taken to improve the model fitting.

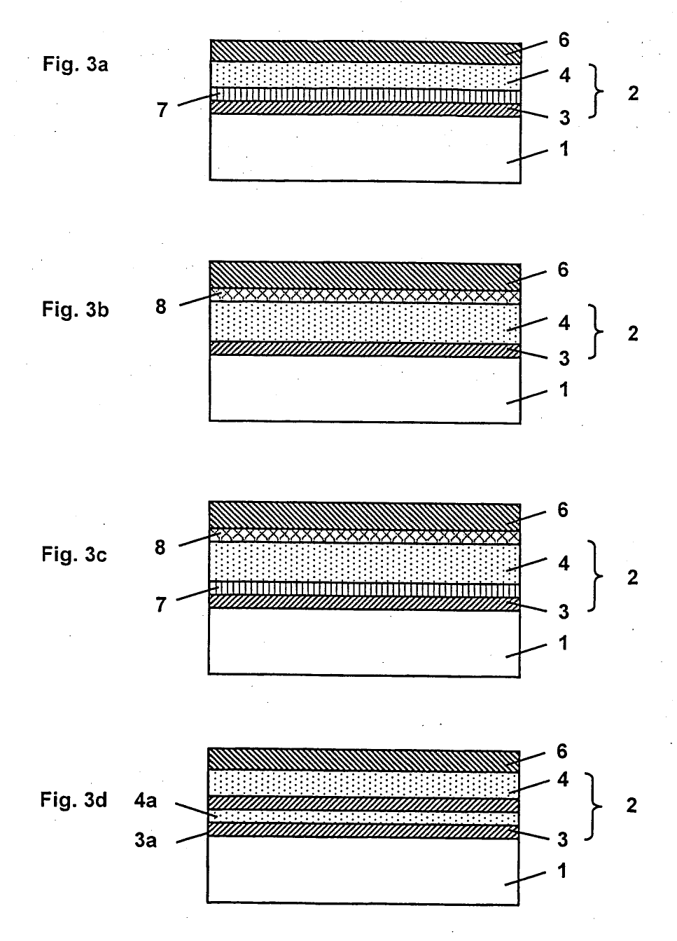

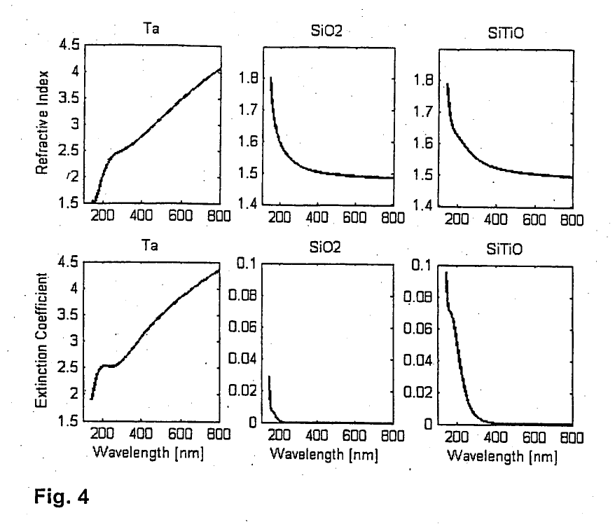

FIG. 4 shows the dispersion curves of Ta and SiO₂. The columns of FIG. 4 show, form left to right, the measured single layer dispersion curves of Ta, and SiO₂. The upper row shows the refractive index n and the lower row the extinction coefficient k.

Table A lists the dispersion values at the lithography wavelengths 157, 193 and 248 nm of these materials and the SiO₂ substrate.

TABLE A

| | | |
|---|---|---|
| 157 nm | 193 nm | 248 nm |

| | n | k | n | k | n | k |
|---|---|---|---|---|---|---|
| Substrate | 1.66 | 0 | 1.56 | 0 | 1.5 | 0 |
| Ta₂O₅ | 1.79 | 1.11 | 2.14 | 1.28 | 3.05 | 0.64 |
| Ta | 1.50 | 2.11 | 1.92 | 2.50 | 2.20 | 2.66 |
| SiO₂ | 1.75 | 0.028 | 1.62 | 0.005 | 1.56 | 0.002 |

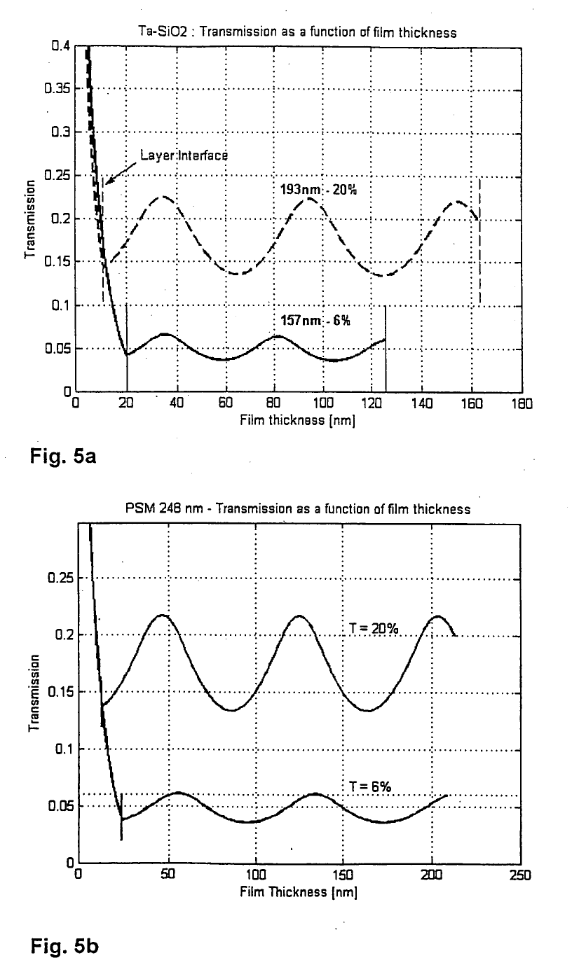

The dispersion data of Table A above was used to carry out the following calculations. All simulations are based on the widely used matrix algorithm as described in A. Macleod, “Thin-film optical filters”, 2^{nd} edition, 1986, Bristol, Adam Hilger, for thin films using Matlab for numerical computations. The results of these simulations are shown in FIGS. 5 to 7.

FIG. 5a illustrates the design for an attenuated 157 nm (6% transmission) and a high transmission 193 nm (20% transmission) phase shift mask blank, FIG. 5b shows the design for an attenuated (6% transmission) and a high transmission 248 nm (20% transmission) phase shift mask blank. In FIG. 5a, the solid line corresponds to the relation of the transmission to the film thickness of the phase shift sublayers for a wavelength of 157 nm and the dashed line corresponds to the transmission as a function of the film thickness of the phase shift sublayers for a wavelength of a 193 nm phase shift mask blank. In FIG. 5b, the upper graph correspond to the transmission as a function of film thickness of the phase shift sublayers for a high transmission and the lower graph for an attenuated phase shift mask blank for a wavelength of 248 nm. In FIGS. 5a and 5b, zero film thickness corresponds to the uncoated substrate. On the substrate, a Ta layer is provided. The graphs show an exponential decrease of transmission with increasing film thickness of the tantalum layer functioning as the transmission control sublayer. On the layer of Ta, a layer of SiO₂ is provided as the phase shift control sublayer. The interface of the transmission control sublayer to the phase shift control sublayer, is indicated by thin vertical lines in each graph of FIGS. 5a and 5b. The dielectric SiO₂ layer shows the typical oscillations around a mean transmission value caused by interference. At the final interface to air the desired transmission value is achieved. Such a phase shift control sublayer does not substantially change the transmission of the phase shift mask blank but has only a minor contribution to the resulting transmission value. The transmission value for zero film thickness is 1, which is truncated for better resolution.

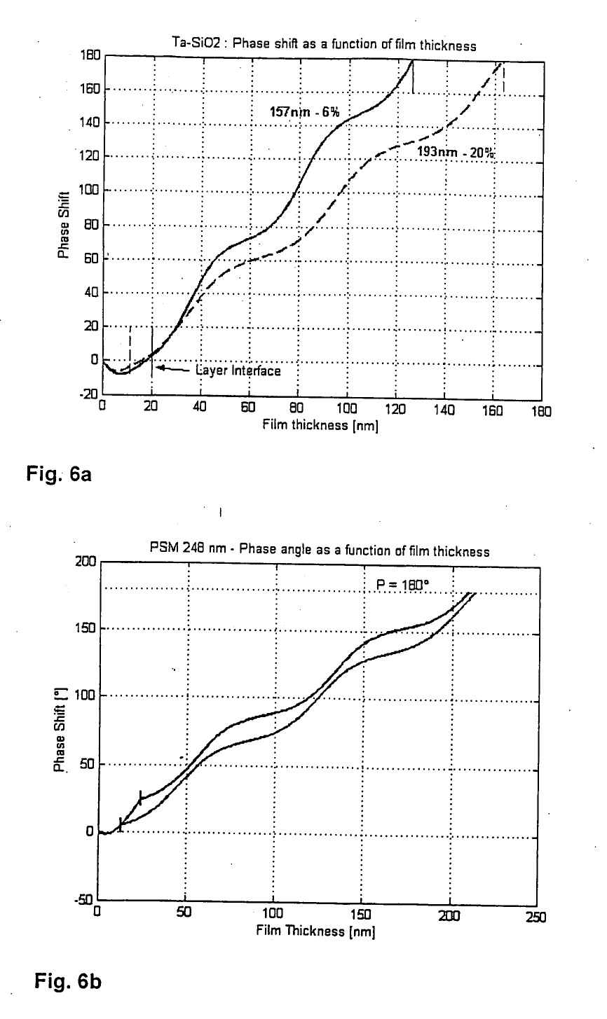

FIGS. 6a and 6b show the phase shift as a function of film thickness. Zero film thickness corresponds to zero phase shift. In FIG. 6a, the phase shift of the tantalum layer is first slightly negative, then rises slightly and at the interface is near zero again. Thus, it has negligible contribution to the total phase shift of the phase shift mask blank. In FIG. 6b, the tantalum layer induces a small positive phase shift to the 248 nm phase shift mask blank. However, compared to the large phase shift of the silicon dioxide layer, the phase shift induced by the tantalum transmission control layer is small. Thus, in a first approximation the dielectric layer produces a linear increase of phase angle with increasing film thickness that is superposed by interference effects. At the final interface to air the desired phase angle of 180° is achieved.

FIGS. 5 and 6 illustrate that phase shift mask blanks for 157 nm, 193 nm and 248 nm allow widely independent control of transmission and phase angle. Adaptation to different wavelengths and transmission requirements is possibly by separately adjusting the thickness of the individual sublayers.

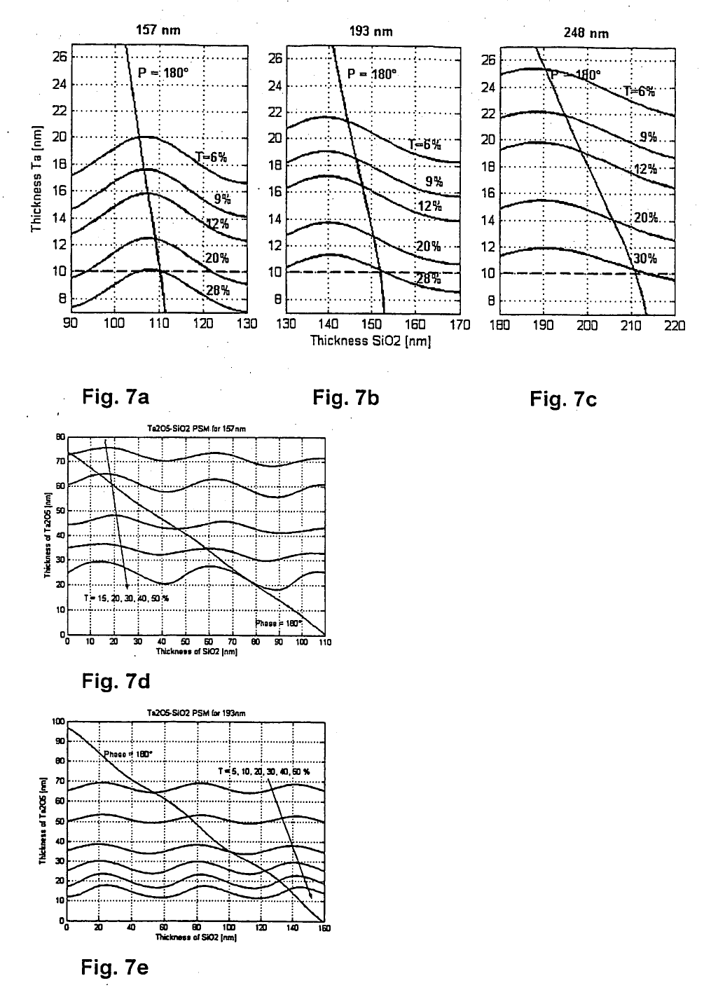

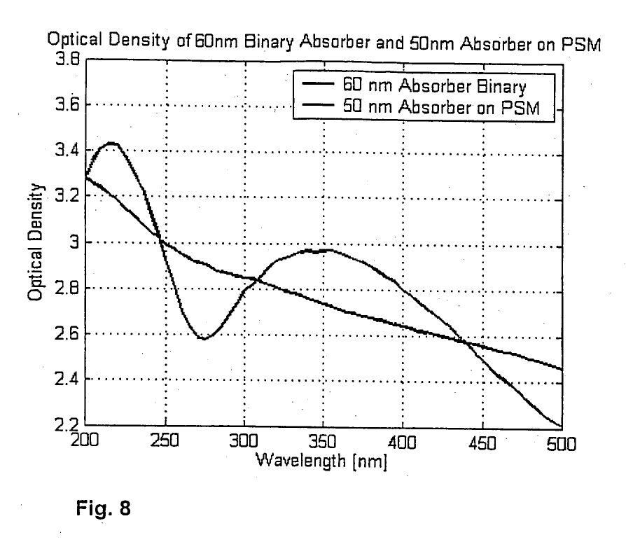

FIGS. 7a to 7e illustrate the tunability of the transmission for five phase shifting systems. On the x-axis the film thickness of SiO₂ is provided and on the y-axis the film thickness of Ta and Ta₂O₅, respectively. The approximately vertical solid line indicates all combinations of film thickness of the SiO₂-layer and the Ta or Ta₂O₅ layer that result in a 180° phase shift. The approximately horizontal graphs correspond to different transmission values corresponding to different sublayer thickness. Line oscillations are caused by interference effects. Such oscillation effects can change the transmission to a substantial amount, however, they do not substantially lower the transmission of the phase shift control sublayer but at most lead to a substantially higher transmission. Since at exposure wavelengths of 300 nm or less, most materials have a very low transmission, an effect such as the described oscillation that may lead to a higher transmission is rather advantageous.

In FIG. 7a to 7e the horizontal oscillating lines show possible film thickness combinations of Ta, Ta₂O₅ and SiO₂ for different transmissions. The vertical line crossing the horizontal lines are combinations of Ta, Ta₂O₅ and SiO₂ yielding a phase shift of 180°. At points designating a certain layer thickness of the tantalum layer and a certain thickness of the SiO₂ layer in that the vertical lines cross the horizontal lines, a phase shift system for a given transmission with a phase shift of 180° can be achieved. Assuming a minimum Ta or Ta₂O₅ layer thickness of 10 nm, transmission can be tuned up to 28% for the 157 nm system (FIG. 6a), 28% for the 193 nm system (FIG. 6b) and 30% for a 248 nm system (FIG. 6c). In the high transmission systems (FIGS. 7d and /e) using Ta₂O₅, transmissions of up to 50% can be achieved. In all cases wavelengths attenuated and high transmission phase shift mask blanks can be produced.

Deposition Experiments

(A) Deposition Tool

All layers were deposited using a dual ion beam sputtering tool as schematically shown in FIG. 1. In particular, a Veeco Nexus LDD Ion Beam Depostition Tool was used for all depositions.

(B) Deposition Parameters

The exact deposition parameters were determined by DOE using as software JMP, release 5.0. 1a, by SAS Institute Inc., SAS Campus Drive, Cary, N.C. 27513, USA. IBD, TW and FW were introduced as fixed parameters, UBD, USD, IBA, UBA and USA were introduced as variables.

Table A shows general deposition parameters for the sputtering of the materials used according to the Examples and Comparative Examples:

TABLE B
General deposition parameters

| | Ta | SiO₂ |
|---|---|---|
| Deposition Source | | |
| Gas flow | 15 sccm | 10 sccm |
| U-Beam | 1500 V | 800 V |
| I-Beam | 400 mA | 200 mA |
| Other | | |
| Target material | Ta (99.95%) | Si (99.999%) |
| Deposition rate | 0.57 Å/s | 0.29 Å/s |
| Background pressure | <3 * 10e−8 Torr | <3 * 10e−8 Torr |
| Deposition pressure | ˜2 * 10e−4 Torr | ˜2 * 10e−4 Torr |

TABLE C
Parameters for sputtering SiO₂

| | Comparative | Comparative | |
|---|---|---|---|
| | Example 1 | Example 2 | Example 1 |
| Deposition Source | | | |
| Sputter Gas | Argon | Xenon | Xenon |
| Gas flow | 38 sccm | 38 sccm | 6 sccm |
| U-Beam (UBD) | 1000 V | 1000 V | 1000 V |
| Decel grid (USD) | −150 V | −150 V | −150 V |
| I-Beam (IBD) | 250 mA | 250 mA | 250 mA |
| Assist Source | | | |
| Sputter Gas | O₂-natural | O₂-ionized | O₂-Extraction |
| Gas flow | 30 sccm | 30 sccm | 30 sccm |
| U-Beam (UBA) | — | — | 150 V |
| Decel grid (USA) | — | — | −300 V |
| I-Beam (IBA) | — | — | 100 mA |
| Best uniformity | 1.6% | 1.0% | 0.2% |

TABLE D
Parameters for sputtering Ta and Ta₂O₅

| | Ta | Ta₂O₅ |
|---|---|---|
| Deposition Source | | |
| Sputter Gas | Argon | Xenon |
| Gas flow | 38 sccm | 38 sccm |
| U-Beam | 1500 V | — |
| Decel grid | | |
| I-Beam | 400 mA | — |
| Assist Source | switched off | |
| Sputter Gas | — | O₂-Extraction |
| Gas flow | | |
| U-Beam | — | — |
| Decel grid | — | — |
| I-Beam | — | — |
| Best uniformity | 0.2% | 0.2% |

### EXAMPLE 1 AND COMPARATIVE EXAMPLE 1 (PSM FOR 157 nm)

Phase shift mask blanks as described schematically in FIG. 2 were manufactured using the standard deposition parameters as outlined above and depositing on a quartz substrate a transmission control sublayer of Ta and on the transmission control sublayer a phase shift control sublayer of SiO₂. The thickness of the deposited layers is outlined in Table 1. On the phase shift control sublayer a standard chromium absorber layer (thickness: 50 nm) was deposited.

TABLE 1

| | Example 1a | Example 1b |
|---|---|---|
| Phase shift mask blank | | |
| exposure wavelength | 157 nm | 157 nm |
| transmission at exposure wavelength | 6% | 20% |
| phase shift | 180° | 180° |
| Substrate | F-quartz | F-quartz |
| Transmission control sublayer | | |
| material | Ta | Ta |
| thickness | 20 nm | 12.5 nm |
| Phase shift control sublayer | | |
| material | SiO₂ | SiO₂ |
| thickness | 106 nm | 109 nm |
| Total thickness of phase shift system | | 121.5 nm |
| Reflection at 256 nm (inspection) | | ≈28% |
| Transmission at 256 nm (inspection) | | ≈10% |

Example 1 and Comparative Examples were repeatedly conducted.

### EXAMPLE 2 (PSM FOR 193 nm)

Phase shift mask blanks as described schematically in FIG. 2 were manufactured using the standard deposition parameters as outlined above and depositing on a quartz substrate a transmission control sublayer of Ta and on the transmission control sublayer a phase shift control sublayer of SiO₂. The thickness of the deposited layers is outlined in Table 2. On the phase shift control sublayer a standard chromium absorber layer (thickness: 50 nm) was deposited.

TABLE 2

| | Example 2a | Example 2b |
|---|---|---|
| Phase shift mask blank | | |
| exposure wavelength | 193 nm | 193 nm |
| transmission at exposure wavelength | 6% | 20% |
| phase shift | 180° | 180° |
| Substrate | quartz | quartz |
| Transmission control sublayer | | |
| material | Ta | Ta |
| thickness | 21 nm | 13 nm |
| Phase shift control sublayer | | |
| material | SiO₂ | SiO₂ |
| thickness | 144 nm | 150 nm |
| Total thickness of phase shift system | | 163 nm |
| Reflection at 256 nm (inspection) | | ≈37% |
| Transmission at 256 nm (inspection) | | ≈16% |

### EXAMPLE 3 (PSM FOR 248 nm, FIG. 2)

Phase shift mask blanks as described schematically in FIG. 2 were manufactured using the standard deposition parameters as outlined above and depositing on a quartz substrate a transmission control sublayer of Ta and on the transmission control sublayer a phase shift control sublayer of SiO₂. The thickness of the deposited layers is outlined in Table 3. On the phase shift control sublayer a standard chromium absorber layer (thickness: 50 nm) was deposited.

TABLE 3

| | Example 3a | Example 3b |
|---|---|---|
| Phase shift mask blank | | |
| exposure wavelength | 248 nm | 248 nm |
| transmission at exposure wavelength | 6% | 20% |
| phase shift | 180° | 180° |
| Substrate | quartz | quartz |
| Transmission control sublayer | | |
| material | Ta | Ta |
| thickness | 25 nm | 14 nm |
| Phase shift control sublayer | | |
| material | SiO₂ | SiO₂ |
| thickness | 190 | 206 |

### EXAMPLE 4 (PSM for 193 nm, HAVING A CONTRAST LAYER)

A phase shift mask blanks as described schematically in FIG. 3a was manufactured using the standard deposition parameters as outlined above and depositing on a quartz substrate a transmission control sublayer of Ta, on the transmission control sublayer a contrast layer of Ta₂O₅ and on the contrast layer a phase shift control sublayer of SiO₂. The thickness of the deposited layers is outlined in Table 4. On the phase shift control sublayer a standard chromium absorber layer (thickness: 50 nm) was deposited.

TABLE 4

| | Example 4a | Example 4b |
|---|---|---|
| Phase shift mask blank | | |
| exposure wavelength | 193 nm | 193 nm |
| transmission at exposure wavelength | 6% | 20% |
| phase shift | 180° | 180° |
| Substrate | quartz | quartz |
| Transmission control sublayer | | |
| material | Ta | Ta |
| thickness | 19 nm | 12 nm |
| Contrast layer | | |
| material | Ta₂O₅ | Ta₂O₅ |
| thickness | 8.5 nm | 5 nm |
| Phase shift control sublayer | | |
| material | SiO₂ | SiO₂ |
| thickness | 140 | 148 |

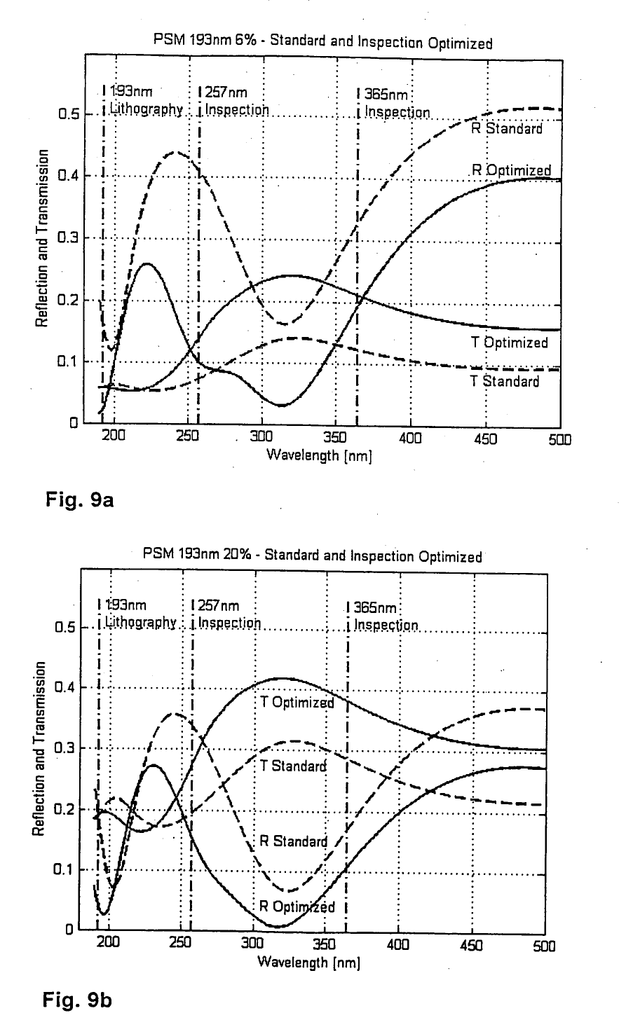

FIGS. 9a and 9b show the improvement on the inspection capability of exemplary mask blanks comprising a contrast layer (Examples 4a and 4b), compared to mask blanks without such a contrast layer (Examples 2a and 2b).

FIG. 9a shows the reflection and transmission for mask blanks for an exposure wavelength of 193 nm having a transmission at 193 nm of 6%; FIG. 9b shows the reflection and transmission for mask blanks for an exposure wavelength of 193 nm having a transmission at 193 nm of 20%. In both cases, the reflection and transmission of the mask blanks comprising a contrast layer (solid lines) are improved compared to the mask blanks without such contrast layer (dashed lines). In addition the reflection at 193 nm also is improved by the contrast layer.

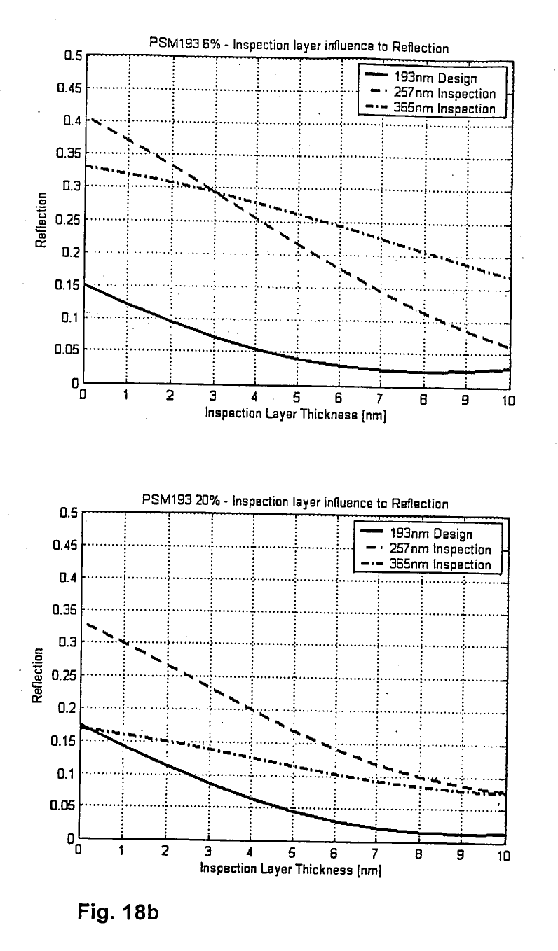

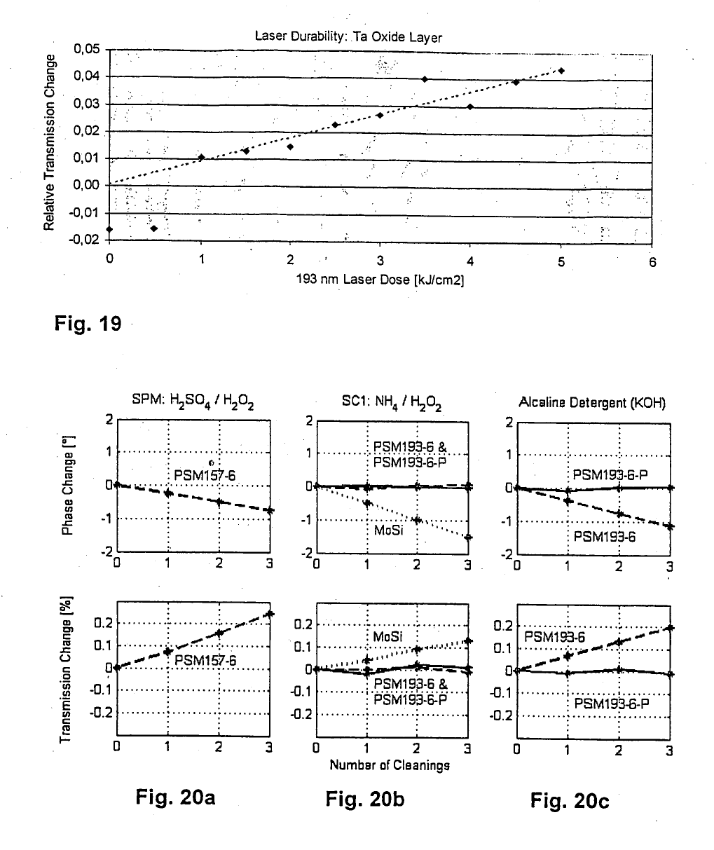

FIGS. 18a and 18b show the influence of the thickness of a contrast layer according to Examples 4a and 4b on the reflection at the exposure wavelength and the inspection wavelengths. A contrast layer having a thickness of less than 10 nm is sufficient to achieve the necessary required reflections. A thickness of zero corresponds to a phase shift system without a contrast layer, i.e. a phase shift system having a phase shift control sublayer and a transmission control sublayer.

FIGS. 17a and 17b show the results of dry etching experiments on mask blanks according to Example 4a (SEM pictures). Pitch sizes are 500 nm (FIG. 17a) and 200 nm (FIG. 17b). The results for isolated line, isolated space and dense lines and spaces are shown. Even for feature sizes of only 100 nm, side wall angles and etch stop capability are very good. The contrast layer was etched by the same dry etching process as the phase shift control sublayer, i.e. a dry etch process using fluorine as the etching agent. Therefore, the addition of the contrast layer does not increase the number of etching steps.

### EXAMPLE 5 (PSM FOR 193 nm, HAVING A PROTECTION LAYER)

A phase shift mask blanks as described schematically in FIG. 3c is manufactured using the standard deposition parameters as outlined above and depositing on a quartz substrate a transmission control sublayer of Ta, on the transmission control sublayer a contrast layer of Ta₂O₅, on the contrast layer a phase shift control sublayer of SiO₂ and on the phase shift control sublayer a protection layer of Ta₂O₅ (thickness: 1 nm). The thickness of the other layers corresponds to those of Example 4a. On the phase shift control sublayer a standard chromium absorber layer (thickness: 50 nm) is deposited.

On the SiO₂ layer of a mask blank according to Example 4a, a layer is deposited using the deposition parameters as outlined above before depositing the Cr absorbing layer. The mask blank then was submitted to the chromium dry etch process (Cl+O₂).

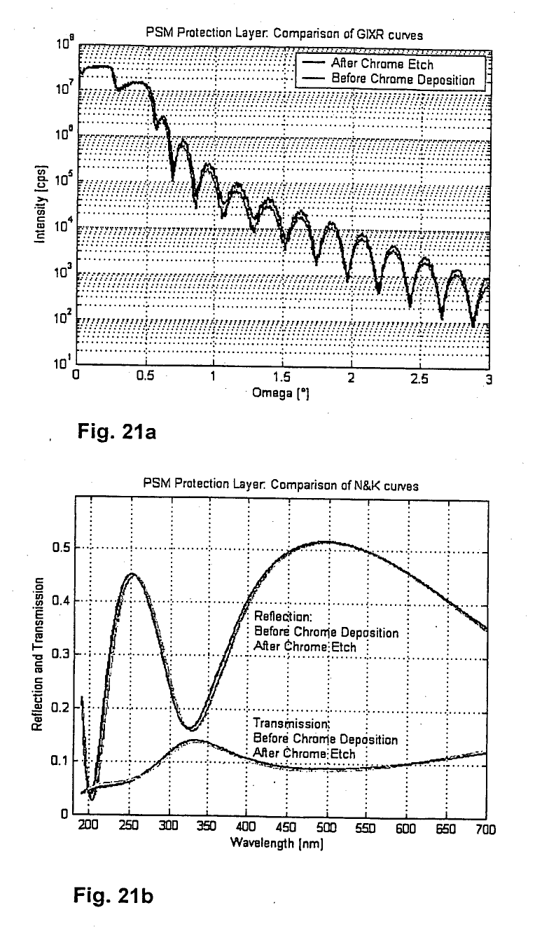

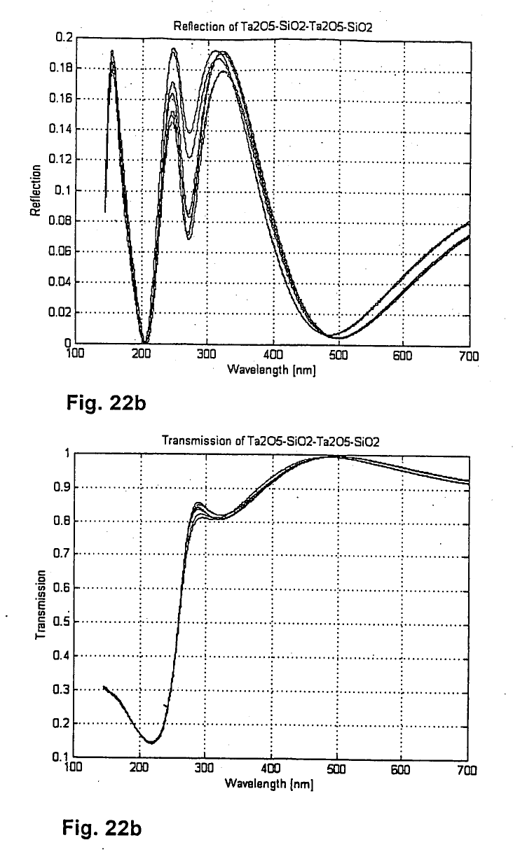

FIG. 21a and FIG. 21b show optical properties of the mask blank according to Example 4 after the chromium dry etch process compared to a mask blank according to Example 4 before deposition of the chromium layer. The grazing incidence X-ray reflection curves (GIXR, FIG. 21a) and the spectral curves (n&k, FIG. 21b) of the mask blank before deposition of Cr and after removal of Cr are the same. This result shows that the thin protection layer is not removed by the chromium dry etch process.

### EXAMPLE 6 (HIGH TRANSMISSION PSM FOR 157 AND 193)

Phase shift mask blanks as described schematically in FIG. 2 were manufactured using the standard deposition parameters as outlined above and depositing on a quartz substrate a transmission control sublayer of Ta₂O₅ and on the transmission control sublayer a phase shift control sublayer of SiO₂. The thickness of the deposited layers is outlined in Table 6. On the phase shift control sublayer a standard chromium absorber layer (thickness: 50 nm) was deposited.

TABLE 6

| | Example 6a | Example 6b |
|---|---|---|
| Phase shift mask blank | | |
| exposure wavelength | 157 nm | 193 nm |
| transmission at exposure wavelength | 20% | 20% |
| phase shift | 180° | 180° |
| Substrate | F-quartz | quartz |
| Transmission control sublayer | | |
| material | Ta₂O₅ | Ta₂O₅ |
| thickness | 64 nm | 3 5 nm |
| Phase shift control sublayer | | |
| material | SiO₂ | SiO₂ |
| thickness | 15 nm | 100 nm |
| Total thickness of phase shift system | 79 nm | 135 nm |
| Reflection at 256 nm (inspection) | 25% | 10% |
| Transmission at 256 nm (inspection) | 30% | 55% |

Compared to Examples 1b (total thickness of phase shift system 125 nm) and 2b (total thickness of phase shift system 163 nm), these phase shift mask blanks provide a transmission of 20%, however, the total thickness of the thin film system can be reduced due to a thinner phase shift system.

### EXAMPLE 7 (PSM FOR 193 nm, 20% TRANSMISSION)

A phase shift mask blanks as described schematically in FIG. 3d is manufactured using the standard deposition parameters as outlined above and depositing on a quartz substrate a first transmission. control sublayer of Ta₂O₅ (thickness: 12 nm), on the first transmission control sublayer a first phase shift control sublayer of SiO₂ (thickness: 12 nm), on the first phase shift control sublayer a second transmission control sublayer of Ta₂O₅ (thickness: 22 nm) and on the second transmission control sublayer a second phase shift control sublayer of SiO₂ (thickness: 92 nm). On the second phase shift control sublayer a standard chromium absorber layer (thickness: 50 nm) is deposited.

Compared to the mask blank of Example 6b, the mask blank according to Example 7 still has a reduced total thickness of the phase shift system (138 nm) when compared with the total thickness of the phase shift system of Example 2b (163 nm), however, the mask blank according to Example 7 has a very low reflection at the exposure wavelength of 193 nm (<4%) and furthermore sufficient low reflection (<20%) and sufficient low transmission (<50%) at the inspection wavelength of 256 nm. FIGS. 22a and 22b show the reflection and the transmission of the mask blank according to Example 7.

Uniformity of Phase Shift and Transmission

The Examples were analyzed using a thickness fit using a N&K photo spectrometer. Using fixed dispersion values the spectrometer calculates the film thickness out of the measured reflection and transmission data. Generally this method is more precise for dielectric layers than for metallic layers. To improve the fit quality for metallic layers dispersion fits were carried out using a fixed film thickness measured before by grazing incidence x-ray reflectometry.

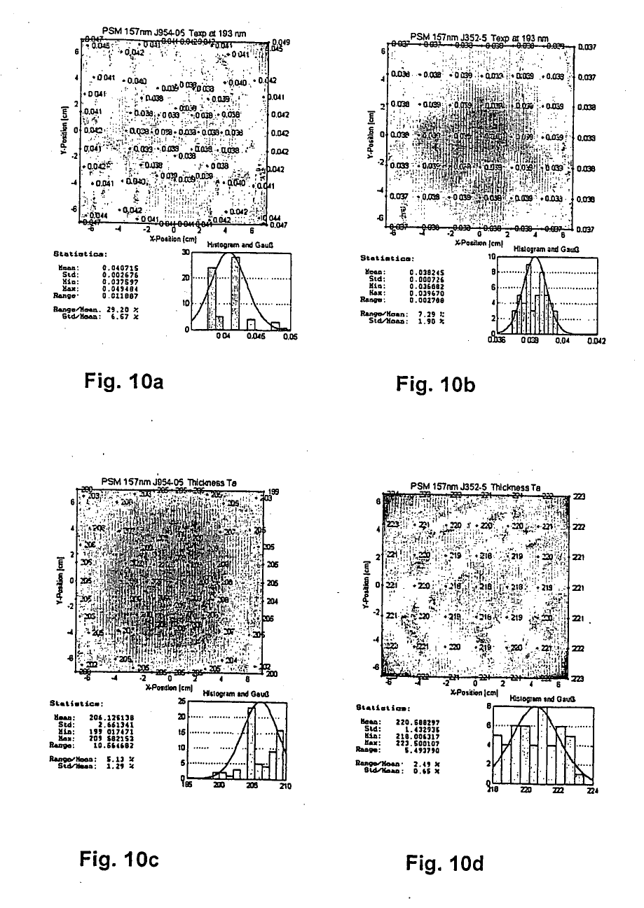

FIGS. 10a to 10d show the result of a mask blank according to Example 1 and Comparative Example 1 for the tantalum layer.

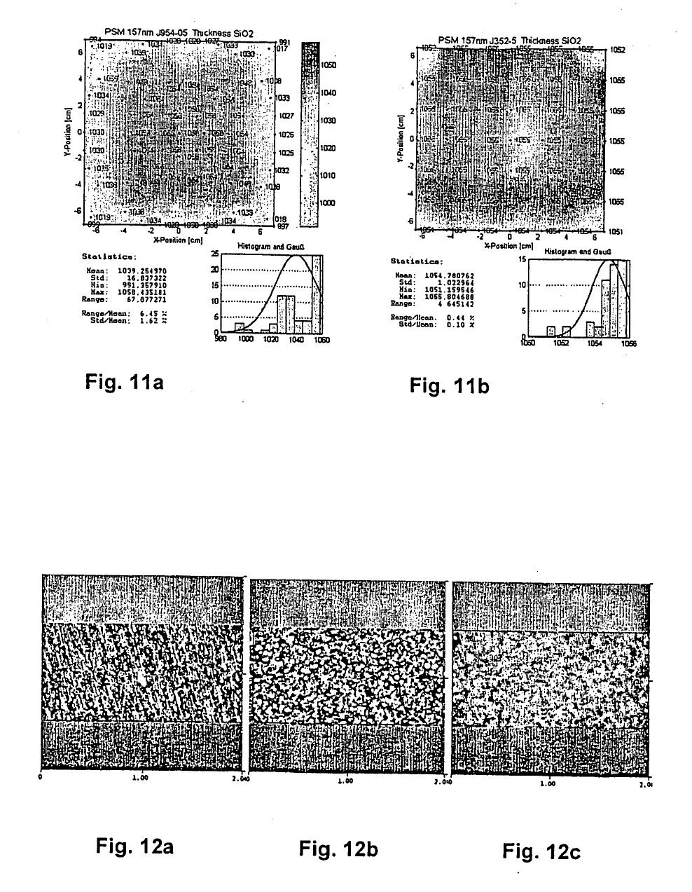

FIG. 11a shows a contour plot of the tantalum layer thickness measured in a 140 mm×140 mm area. The range/mean uniformity value including the corners is 5.4%. Excluding the comer points the value is 2.9%.

FIG. 11b shows the contour plot for the SiO₂ layer. Here the range/mean uniformity value including the corners is 6.5%. Excluding the corner points the value is 3.2%.

Measurement of Defect Levels

Defects levels were measured using a high resolution laser scanner defect inspection tool. Both surfaces of the blank are scanned line by line by a laser beam. The reflected and transmitted stray light is detected by two photo multipliers. The software calculates class, location and size of the particles out of the four measured signals. The results are displayed as location maps and size histograms. In the maps particle sizes are reduced to three classes, i.e. particles from about 0.2 to 0.5 μm, particles between 0.5 μm and 1 μm and particles above 1 μm. Dots indicate particles from about 0.2 to 0.5 μm, circles and squares would indicate particles of larger particle sizes.

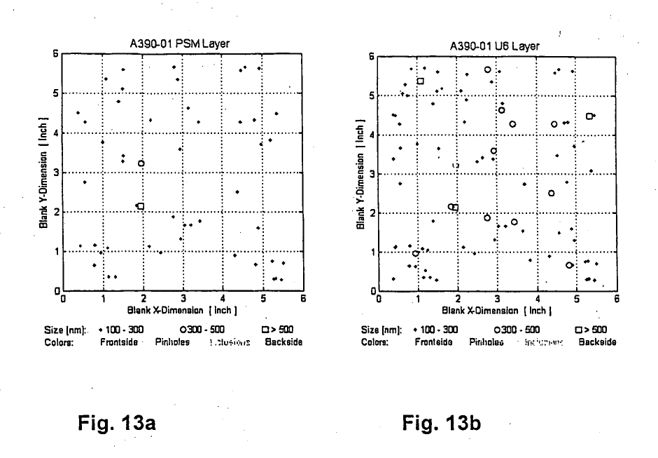

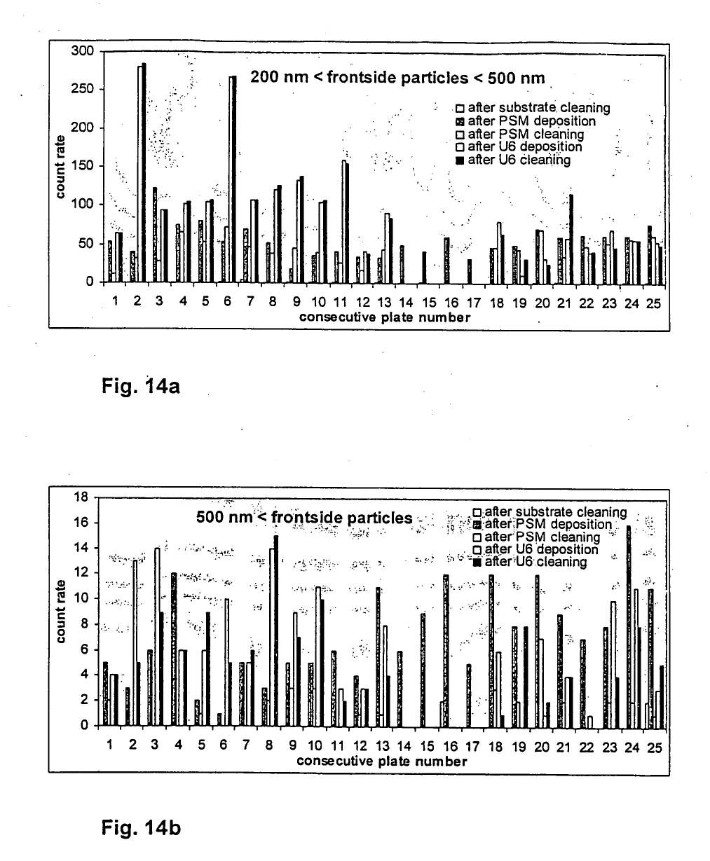

FIGS. 13a and 13b show the particle level of an inventive phase shift mask blank according to the Example. FIG. 13a shows the particle map of the phase shift layer, and FIG. 13b shows the particle map of the phase shift layer covered with an absorbing chrome layer. FIGS. 14a and 14b show the effect of cleaning steps on the particle level for a series of examples.

Chemical Durability Tests

The chemical durability of mask blanks according to the Examples against different cleaning agents was tested and compared with commercial phase shift mask blanks.

FIGS. 20a to 20c show the result of these tests. Each upper chart of each FIG. shows the change of the phase shift of the mask blank after treatment with a cleaning agent, the lower chart shows the change of the transmission of the mask blank after treatment with a cleaning agent.

FIG. 20a shows the phase change and the transmission change of a mask lank according to Example 1 before and after several cleaning cycles with an acidic cleaning agent (H₂SO₄/H₂O₂ at 90° C.). Although the transmission and the phase shift change slightly after each cleaning cycle, these changes are still within the required specifications for phase shift mask blanks. The same results were obtained, when phase shift mask blanks according to Examples 2 and 3 were submitted to the same acidic cleaning agent. Therefore, the phase shift mask blank of the present invention show an excellent chemical durability against acidic cleaning agents.

FIG. 20b shows the phase change and the transmission change of a mask blank according to Example 2 (in the FIG.: PSM 193-6), a mask blank according to Example 4 (in the FIG.: PSM 193-6P) and a commercial molybdenum silicide phase shift mask blank (for 193 nm, 6% transmission in the FIG.: MoSi) before and after several cleaning cycles with a standard alkaline cleaning agent (NH₄/H₂O₂). Whereas phase shift and transmission of the MoSi mask blank change due to the cleaning, no such change can be seen in case of the mask blanks according to Examples 2 and 4. The same results (no change of phase shift and transmission) were obtained when submitting mask blanks according to Examples 1, 3 and 5 to the same cleaning cycles. Therefore, the phase shift mask blank of the present invention show an excellent chemical durability against standard alkaline cleaning agents.

FIG. 20 shows the phase change and the transmission change of a mask blank according to Example 2 (in the FIG.: PSM 193-6) and a mask blank according to Example 4 (in the FIG.: PSM 193-6P) before and after several cleaning cycles with a further alkaline cleaning agent (KOH, pH 12 at 50° C.).

Whereas phase shift and transmission of the mask blank according to Example 2 slightly changes due to the cleaning, no such change can be seen in case of the mask blanks according to Examples 4. Thus, it can be seen that the already excellent chemical durability of the mask blanks of the present invention against alkaline cleaning agents can be further improved by providing a protection layer on a SiO₂ layer.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A dual ion-beam deposition process for preparing an embedded attenuated phase shift mask blank, said mask blank comprising a substrate and a thin film system, said mask blank being able of producing a photomask with substantially 180° phase shift and an optical transmission of at least 0.001% at an exposure light having a wavelength of 300 nm or less; the process comprising depositing on the substrate
a transmission control sublayer comprising one or more metals or metal compounds selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, borides and carbides thereof, and combinations of metals and compounds thereof;
a phase shift control sublayer comprising borides, carbides, oxides and/or nitrides of Ge, Si and/or Al or combinations thereof;
wherein at least one layer of the thin film system is deposited by
(c) ion beam deposition from a target of a mixture, alloy or compound containing one or more of Si, Al, Mg, Y, La, Ti, Zr, Hf, V, Nb, Ta, Cr, Mo, W, Mn, Fe, Co, Ni, Zn, Ge, Sn, Pb by ions from a group of gases using a primary ion beam, and
(d) bombarding the substrate using a secondary ion beam from an assist source comprising a group of gasses.

2. The process according to claim 1, wherein the parameters for said primary ion beam and said secondary ion beam are modulated to provide a mean uniformity of the thickness of said layer of at most 2%.

3. The process according to claim 1, wherein at least two layers of the thin film system are deposited by ion beam deposition from a target of a mixture, alloy or compound of one or more of Si, Al, Mg, Y, La, Ti, Zr, Hf, V, Nb, Ta, Cr, Mo, W, Mn, Fe, Co, Ni, Zn, Ge, Sn, Pb by ions from a group of gases using a primary ion beam.

4. The process according to claim 3, wherein at least two layers of the thin film system are deposited by bombarding the substrate using a secondary ion beam from an assist 'source comprising a group of gasses.

5. The process according to claim 3, wherein at least two layers of the thin film system are deposited without interrupting the vacuum during the deposition process.

6. The process according to claim 1, the process comprising depositing on the substrate
a transmission control sublayer comprising a metal and/or metal compound in an amount of at least 90 at.-%, wherein the metal or metal compound is selected from the group consisting of Mg, Y, La, Ti, Zr, Hf, V, Nb, Ta, Cr, Mo, W, Mn, Fe, Co, Ni, Zn, Ge, Sn, Pb, oxides and nitrides thereof; and combinations of. metals and compounds thereof.

7. The process according to claim 1, the process comprising depositing on the substrate
a transmission control sublayer comprising Ta, oxides thereof, nitrides thereof and/or combinations thereof.

8. The process according to claim 1, the process comprising depositing on the substrate:
a phase shift control sublayer comprising oxides or oxy nitrides of Ge, Si and/or Al or combinations thereof in an amount of at least 90 at.-%.

9. An embedded attenuated phase shift photo mask blank, the mask blank comprising a substrate and a thin film system, said thin film system comprising
a transmission control sublayer comprising a metal and/or metal compound selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, borides and carbides thereof and combinations of metals and compounds thereof;
a phase shift control sublayer comprising borides, carbides, oxides and/or nitrides of Ge, Si and/or Al or combinations thereof;
wherein the transmission control sublayer and/or the phase shift control sublayer have a mean uniformity of film thickness of at most 2%; said mask blank being able of producing a photomask with substantially 180° phase shift and an optical transmission of at least 0.001% at an exposure light having a wavelength of 300 nm or less;

10. The mask blank according to claim 9, wherein the transmission control sublayer and the phase shift control sublayer have a mean uniformity of film thickness of at most I %.

11. The mask blank according to claim 9, wherein the mask blank comprises a substrate an a thin film system, said thin film system comprising
a layer consisting essentially of a metal and/or metal compound selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, borides and carbides thereof and combinations of metals and compounds thereof;
a layer comprising borides, carbides, oxides and/or nitrides of Ge, Si and/or Al or combinations thereof in an amount of at least 95 at.-%.

12. The mask blank according to claim 9, wherein the mask blank has a transmission of from 5% to 30% at a wavelength of 157 nm, 193 nm, or 248 nm.

13. An embedded attenuated phase shift mask blank, the mask blank comprising a substrate and a thin film system, said thin film system prising a substrate and a thin film system, said thin film system comprising
a transmission control sublayer comprising one or more metals and/or metal nitrides selected from the group consisting of Y, La, Ti, Zr, Hf, V, Nb, Ta, Cr, Mo, W, Mn, Fe, Co, Ni, Zn, Ge, Sn, Pb, nitrides thereof and combinations of metals and nitrides thereof; in an amount of at least 90 at.-%;
a phase shift control sublayer comprising oxides and/or oxy nitrides of Ge, Si and/or Al or combinations thereof; in an amount of at least 90 at.-%;
said phase shift mask being able of producing a photomask with substantially 180° phase shift and an optical transmission of at least 0.001% at an exposure light having a wavelength of about 248 nm.

14. The mask blank according to claim 13, wherein the phase shift control sublayer comprises SiO₂ in an amount of at least 95 at.-%.

15. The mask blank according to claim 13, wherein the transmission control sublayer comprises a metal or metal nitride selected from the group consisting of Y, La, Ti, Zr, Hf, V, Nb, Ta, Cr, Mo, W, Mn, Fe, Co, Ni, Zn, Ge, Sn, Pb, nitrides thereof and combinations thereof; in an amount of at least 95 at.-%.

16. An embedded attenuated phase shift mask blank, comprising a substrate and a thin film system comprising
a transmission control sublayer comprising one or more metals and/or metal nitrides selected from the group consisting of Y, La, Ti, Zr, Hf, V, Nb, Ta, Cr, Mo, W, Mn, Fe, Co, Ni, Zn, Ge, Sn, Pb, nitrides thereof and combinations thereof; in an amount of at least 90 at.-%;
a contrast layer comprising one or more metal oxides in an amount of at least 90 at.-%;, wherein the metal is selected from the group consisting of Y, La, Ti, Zr, Hf, V, Nb, Ta, Cr, Mo, W, Mn, Fe, Co, Ni, Zn, Ge, Sn, Pb, and combinations thereof;
a phase shift control sublayer comprising oxides or nitrides of Ge, Si and/or Al and/or combinations thereof; in an amount of at least 90 at.-%;
said mask blank being able of producing a photomask with substantially 180° phase shift and an optical transmission of at least 0.001% at an exposure light having a wavelength of 300 nm or less.

17. The mask blank according to claim 16, wherein the transmission control sublayer is provided on the substrate, the contrast layer is provided on the transmission control layer, and the phase shift control sublayer is provided on the contrast layer.

18. The mask blank according to claim 16, wherein the transmission control sublayer is provided on the substrate, and the phase shift control sublayer is provided on the transmission control sublayer and the contrast layer is provided on the phase shift control sublayer.

19. The mask blank according to claim 16, wherein the phase shift control sublayer comprises SiO₂ in an amount of at least 95 at.-%.

20. The mask blank according to claim 16, wherein the transmission control sublayer comprises Ta and/or Ta nitride in an amount of at least 95 at.-%.

21. The mask blank according to claim 16, wherein the contrast layer comprises Ta₂O₅ in an amount of at least 95 at.-%.

22. An embedded attenuated phase shift mask blank, wherein the mask blank comprises a substrate and a thin film system comprising
a transmission control sublayer comprising one or more metals or metal nitrides selected from the group consisting of Y, La, Ti, Zr, Hf, V, Nb, Ta, Cr, Mo, W, Mn, Fe, Co, Ni, Zn, Ge, Sn, Pb, nitrides thereof and combinations thereof; in an amount of at least 90 at.-%;
a phase shift control sublayer comprising Si and/or Al;
a protection layer provided on the phase shift control sublayer, comprising a metal and/or compound selected from the group consisting of Mg, Y, La, Ti, Zr, Hf, V, Nb, Ta, Cr, Mo, W, Mn, Fe, Co, Ni, Zn, Ge, Sn, Pb, oxides, nitrides, carbides, borides and combinations thereof, said protection layer having a thickness of at most 5 nm;
said mask blank being able of producing a photomask with substantially 180° phase shift and an optical transmission of at least 0.001% at an exposure light having a wavelength of 300 nm or less.

23. The mask blank according to claim 22, wherein the transmission control sublayer is provided on the substrate and the phase shift control sublayer is provided on the transmission control sublayer.

24. The mask blank according to claim 22, wherein the phase shift control sublayer comprises oxides and/or nitrides of Si in an amount of at least 90 at.-%.

25. The mask blank according to claim 22, wherein the protection layer comprises an oxide of a metal in an amount of at least 90 at.-%, wherein the metal is selected from the group consisting of Al, Mg, Y, La, Ti, Zr, Hf, V, Nb, Ta, Cr, Mo, W, Mn, Fe, Co, Ni, Zn, Ge, Sn, Pb, and combinations thereof.

26. An embedded attenuated phase shift mask blank, wherein the mask blank comprises a substrate and a thin film system, said thin film system comprising
a transmission control sublayer comprising one or more oxides of a metal in an amount of at least 90 at.-%; wherein the metal is selected the from the group consisting of Y, La, Ti, Zr, Hf, V, Nb, Ta, Cr, Mo, W, Mn, Fe, Co, Ni, Zn, Ge, Sn, Pb, and combinations thereof;
a phase shift control sublayer comprising oxides and/or oxy nitrides of Si and/or Al or combinations thereof; in an amount of at least 90 at.-%
said phase shift mask blank being able of producing a photomask with substantially 1800 phase shift and an optical transmission of at least 20% at an exposure light having a wavelength of 300 nm or less.

27. The mask blank according to claim 26, wherein said thin film system comprises in an alternating order
a first transmission control sublayer comprising one or more oxides of a metal in an amount of at least 90 at.-%, wherein the metal is selected the from the group consisting of Y, La, Ti, Zr, Hf, V, Nb, Ta, Cr, Mo, W, Mn, Fe, Co, Ni, Zn, Ge, Sn, Pb, and combinations thereof;
a first phase shift control sublayer comprising oxides and/or oxy nitrides of Si and/or Al or combinations thereof; in an amount of at least 90 at.-%;
a second transmission control sublayer comprising one or more oxides of a metal in an amount of at least 90 at.-%, wherein the metal is selected the from the group consisting of Y, La, Ti, Zr, Hf, V, Nb, Ta, Cr, Mo, W, Mn, Fe, Co, Ni, Zn, Ge, Sn, Pb, and combinations thereof;
a second phase shift control sublayer comprising oxides and/or oxy nitrides of Si and/or Al or combinations thereof in an amount of at least 90 at.-%.
